(19) United States
(12) Patent Application Publication
(10) Pub. No.: US 2026/0351089 A1
(43) Pub. Date: Nov. 5, 2026

(54) SYSTEM AND METHOD FOR MANAGING STAGED CONTINUATION OF WAGERS WITHIN A SHARED MULTIPLAYER GAME ROUND

(71) Applicant: Aviatrix Technologies, Inc., Ewing, NJ (US)

(72) Inventors: Mikalai Pobal, Limassol (CY); Uladzislau Artsemyeu, Limassol (CY); Anton Yarash, Vilnius (LT)

(21) Appl. No.: 19/696,321

(22) Filed: Jun. 3, 2026

(51) Int. Cl. G07F 17/32

(52) U.S. Cl. CPC G07F 17/3272; G07F 17/3244

(57) ABSTRACT

The present invention discloses a system and method for managing staged continuation of wagers within a shared multiplayer game round. The system comprises a wager interface, a round state generator, a progression controller, a survival engine, and a settlement controller. The wager interface receives wagers associated with the shared multiplayer game round. The round state generator generates round state data, including crash stage data and player continuation data, based on the received wagers. The progression controller initiates and controls the progression of a game multiplier using the crash stage data. The survival engine evaluates active wagers using the player continuation data to determine whether each wager continues or terminates responsive to the multiplier reaching a crash stage. The settlement controller determines a settlement outcome based on the multiplier value at a termination point responsive to the wager's termination. The progression controller maintains wagers determined to continue as the same original wagers within the shared multiplayer game round, while terminated wagers are resolved independently. Therefore, the system and method enable efficient management of multiplayer wagering sessions while supporting individualized wager progression and outcome determination within a common game instance.

### FIELD OF THE INVENTION

The present invention relates to the field of digital gaming systems and online wagering platforms, and more particularly to a system and method for managing the staged continuation of wagers within a shared multiplayer game round, including controlling multiplier progression and evaluating whether individual wagers continue or terminate at defined stages during the round. This enables individualized wager outcomes within a common multiplayer game instance.

### BACKGROUND

### Interpretation Considerations

This section describes the field of the invention in detail and discusses problems encountered therein. Therefore, statements in the section are not to be construed as prior art.

### Discussion

Online multiplayer wagering games, including multiplier-based or crash-style games, have gained significant popularity due to their rapid gameplay and real-time multiplayer participation. In such games, multiple players participate in a shared game round in which a game parameter, typically a multiplier, increases progressively from an initial value. Players place wagers associated with the multiplier and attempt to secure payouts by cashing out before the round terminates at a crash point. These games are commonly implemented using networked client-server architectures that synchronize game state across players' devices, display multiplier progression in real time, and settle wagers based on game outcomes.

In conventional implementations of such games, each round is associated with a single randomly determined crash point. The multiplier increases continuously until the crash point, at which point the round terminates. Players who cash out before the crash receive payouts corresponding to the multiplier value at the time of cash-out, while players who fail to cash out before the crash lose their wagers. As a result, all wagers within the round are resolved simultaneously based on the same crash event. While this approach provides a simple and uniform gameplay model, it yields binary outcomes in which all wagers are subject to the same termination condition.

Some existing systems introduce additional gameplay features such as automated betting, automated cash-out thresholds, or support for multiple simultaneous wagers. Other implementations incorporate auxiliary mechanisms such as insurance, rebuy, or rescue-style features that allow players to recover or re-enter gameplay after a loss. However, such mechanisms are typically implemented as separate wagers, separate game states, or additional player actions rather than allowing a single wager to persist across multiple events within the same round. Consequently, these approaches offer limited flexibility for differentiated wager outcomes over the course of a shared round.

A further limitation of conventional architectures is that they generally lack mechanisms for selectively allowing certain wagers to continue while terminating others within the same multiplayer round. When the crash point occurs, all remaining wagers are resolved simultaneously, preventing staged continuation in which some wagers may survive an initial crash event and continue toward subsequent progression thresholds. Providing multiple chances to wager typically requires restarting gameplay or starting a new round, which may disrupt synchronization among participating clients and diminish the shared multiplayer experience.

Additionally, conventional implementations often lack a unified mechanism to coordinate the progression of synchronized multipliers, player-specific wager outcomes, and real-time settlement processing within a single-round structure. When additional continuation features are introduced as separate gameplay elements, they may increase system complexity, complicate the auditing of wager settlements, and create user interface challenges in communicating the status of wagers that continue or terminate at different points during gameplay.

Accordingly, there exists a need for an improved gaming system capable of maintaining a shared multiplayer game round with a common multiplier progression while enabling selective continuation of individual wagers across multiple sequential crash stages. Such a system would allow player-specific wager outcomes within the same round, support synchronized and auditable settlement processing, and enhance gameplay engagement by providing multiple in-round progression opportunities without requiring separate rounds or additional wagers.

### SUMMARY

An objective of the present invention is to provide a system and method for managing wagers within a shared multiplayer game round while allowing individual wager outcomes to be processed independently.

Another objective of the present invention is to provide a system and method that includes a mechanism for generating round state data, with predetermined progression stages to control multiplier advancement during gameplay.

A further objective of the present invention is to provide a system and method that includes a continuation evaluation mechanism for determining whether active wagers remain eligible to proceed at defined stages during multiplier progression.

Yet another objective of the present invention is to provide a system and method that includes a structured wager state management and settlement mechanism for determining payout outcomes based on a multiplier value at a termination point.

This and other objectives are achieved by providing a system and method for managing staged continuation of wagers within a shared multiplayer game round as defined in the features of the independent claims. Additional advantageous embodiments and improvements of the invention are listed in the dependent claims. The use of expressions like “. . . aspect according to the invention” or “in one embodiment” or similar terminology is intended to refer to examples or embodiments consistent with the broadest scope of the invention as defined by the independent claims.

According to a first aspect, the present invention discloses a system for managing staged continuation of wagers within a shared multiplayer game round. The system comprises a wager interface, a round state generator, a progression controller, a survival engine, and a settlement controller. The wager interface receives wagers associated with the shared multiplayer game round. The round state generator to generate round state data, including crash stage data and player continuation data, based on the received wagers. The progression controller initiates and controls the progression of a game multiplier using the crash stage data. The survival engine to evaluate active wagers using the player continuation data to determine whether each wager continues or terminates responsive to the multiplier reaching a crash stage. The settlement controller determines a settlement outcome based on the multiplier value at a termination point responsive to termination of a wager. The progression controller maintains wagers determined to continue as the same original wagers within the shared multiplayer game round, while terminated wagers are resolved independently. This system arrangement allows wagers to be evaluated and resolved independently while a shared game round remains active. This improves management of multiple wagers within a common game environment.

In an embodiment of the present invention, the crash stage data comprises an ordered sequence of two or more crash multipliers. The use of multiple crash multipliers enables the evaluation of wagers at more than one progression point. This supports staged outcome determination during gameplay.

In an embodiment of the present invention, the crash stage data defines successive crash stages occurring during multiplier progression. These successive, defining stages provide a structured sequence for evaluating events during multiplier progression. This enables the orderly processing of the wager outcome.

In another embodiment of the present invention, the round state generator generates the crash stage data before initiation of the shared multiplayer game round. This generation of the crash stage data before round initiation makes the required data available before gameplay begins. This enables immediate use of the data during multiplier progression.

In another embodiment of the present invention, the player continuation data comprises stage-specific continuation eligibility values. These stage-specific eligibility values allow continuation determinations to be associated with individual stages. This enables stage-dependent evaluation of wagers.

In another embodiment of the present invention, the survival engine determines continuation eligibility by retrieving continuation indicators from the round state data. This retrieving of continuation indicators from stored round state data enables continuation determinations to be made using predefined data. This facilitates consistent evaluation of wagers.

In another embodiment of the present invention, the wagers determined to be ineligible for continuation are transitioned into a terminated state. This transitioning of ineligible wagers into a terminated state establishes a defined outcome for such wagers. This enables subsequent settlement processing.

In another embodiment of the present invention, the wagers having continuation eligibility are maintained in a continuation state, allowing progression to a subsequent crash stage. Thus, maintaining eligible wagers in a continuation state enables those wagers to remain active. This allows participation in a subsequent stage.

In yet another embodiment of the present invention, the progression controller temporarily pauses multiplier progression at a crash stage before evaluation of wagers. The multiplier progression resumes after continuation wagers are determined. This pausing of the multiplier progression at a crash stage provides an opportunity to perform wager evaluation before further progression. This supports stage-based determination of continuation.

In yet another embodiment of the present invention, the crash stage data is generated using a randomization process. The generation of the crash stage data using randomization produces variable crash multipliers between rounds. This enables a non-deterministic stage value.

In yet another embodiment of the present invention, the player continuation data is generated independently from the crash stage data. This independent generation of continuation data and crash stage data separates the respective data sources. This allows continuation determinations to be established without dependency on crash stage generation.

In yet another embodiment of the present invention, the continuation eligibility is determined using stage-specific probability values. The use of stage-specific probability values enables probabilistic determination of continuation eligibility. This allows configurable continuation likelihood at different stages.

In still another embodiment of the present invention, the continuation eligibility is determined using one or more random seeds. The one or more random seeds are stored in a memory module to enable reproduction of continuation determinations. The stored random seeds enable reproduction of continuation determinations. This allows the determinations to be regenerated when required.

In still another embodiment of the present invention, continuation eligibility is determined using both precomputed continuation data and runtime evaluation. The use of both precomputed continuation data and runtime evaluation enables the determination of continuation eligibility from multiple evaluation sources. This supports hybrid determination processing.

In still another embodiment of the present invention, each wager is associated with a wager state selected from active, continuation, terminated, or settled. The association of each wager with a defined wager state enables tracking of wager status. This supports state-based management of wagers.

In still another embodiment of the present invention, the settlement controller calculates payouts for wagers terminated by a cash-out instruction based on the multiplier value at a time of termination. The calculation of payouts based on the multiplier value at the time of termination enables payout determination using the termination multiplier. This provides a defined basis for payout calculation.

According to a second aspect, the present invention discloses a method for managing staged continuation of wagers within a shared multiplayer game round. The method comprises the steps of a) receiving wagers for the shared multiplayer game round; b) generating round state data, including crash stage data and player continuation data, based on the received wagers; c) initiating progression of a multiplier using the crash stage data; d) evaluating active wagers using the player continuation data to determine whether each wager continues or terminates responsive to the multiplier reaching a crash stage; e) continuing the shared multiplayer game round for wagers determined to continue as the same original wagers; and f) settling terminated wagers based on the multiplier value at a termination point. This recited sequence of steps enables staged evaluation and settlement of wagers within the shared round. This provides a structured operational process.

According to a third aspect, the present invention discloses a method for managing staged continuation of wagers within a shared multiplayer game round. The method comprises the steps of: a) generating round state data, including crash stage data and player continuation data; b) initiating and controlling the progression of a game multiplier during the shared multiplayer game round using the crash stage data; c) evaluating continuation eligibility of wagers at each crash stage using the player continuation data; d) transitioning wagers determined to be ineligible for continuation into terminated states; e) maintaining wagers determined to be eligible for continuation in continuation states, allowing progression to a subsequent crash stage as the same original wagers; and f) determining settlement outcomes for terminated wagers based on a multiplier value at a termination point; wherein the shared multiplayer game round is maintained while wagers independently continue or terminate at different crash stages based on the player continuation data. This enables efficient concurrent management of multiple wagers within a single game round while providing controlled progression, improved system scalability, and enhanced gameplay continuity.

According to a fourth aspect, the present invention discloses a system for managing staged continuation of wagers within a shared multiplayer game round. The system comprises a wager interface, a round state generator, a progression controller, a continuation evaluation engine, and a settlement controller. The wager interface receives wagers associated with the shared multiplayer game round. The round state generator generates round state data, including stage event data and player continuation data associated with a plurality of continuation checkpoints during the shared multiplayer game round. The progression controller controls the progression of a game parameter through successive continuation checkpoints. The continuation evaluation engine evaluates active wagers at respective continuation checkpoints using the player continuation data to determine whether individual wagers continue or terminate at corresponding stage events. The settlement controller determines settlement outcomes for terminated wagers based on a value of the game parameter at a termination point. The wagers determined to continue remain active within the shared multiplayer game round as the same original wagers without requiring re-entry, rebuy, replacement, duplication, or placement of additional wagers, and terminated wagers are resolved independently while the shared multiplayer game round continues for remaining active wagers. This arrangement enables the continued participation of surviving wagers in the same multiplayer game round without requiring additional wager placement, while improving gameplay continuity, synchronization efficiency, and the auditability of independently resolved wager outcomes.

### BRIEF DESCRIPTION OF THE DRAWINGS

Various aspects, as well as embodiments of the present invention, are better understood by referring to the following detailed description. To better understand the invention, the detailed description should be read in conjunction with the drawings. The illustrated embodiments are merely examples and are not intended to limit the disclosure. The schematics are drawn to illustrate features and concepts and are not necessarily drawn to scale.

FIG. 1 illustrates a block diagram of a system for managing staged continuation of wagers within a shared multiplayer game round in accordance with an exemplary embodiment of the present invention;

FIG. 2 illustrates a structured representation of round state data in accordance with an exemplary embodiment of the present invention;

FIG. 3 illustrates a multiplier progression and crash stage control architecture 300 in accordance with an exemplary embodiment of the present invention;

FIG. 4 illustrates a continuation eligibility evaluation architecture in accordance with an exemplary embodiment of the present invention;

FIG. 5 illustrates a wager state transition model in accordance with an exemplary embodiment of the present invention;

FIG. 6 illustrates a randomization and seed-based determination architecture 600 in accordance with an exemplary embodiment of the present invention;

FIG. 7 illustrates a hybrid continuation determination model in accordance with an exemplary embodiment of the present invention;

FIG. 8 illustrates a shared multiplayer game round with independent wager outcomes in accordance with an exemplary embodiment of the present invention;

FIG. 9 illustrates an integrated system operation flow in accordance with an exemplary embodiment of the present invention;

FIG. 10 illustrates a flowchart of a method for managing staged continuation of wagers within a shared multiplayer game round in accordance with an exemplary embodiment of the present invention;

FIG. 11 illustrates a wager interface configured as a banner display for presenting a selectable wagering instance in accordance with an exemplary embodiment of the present invention;

FIG. 12 illustrates a wager interface configured as an onboarding screen that introduces features of the wagering environment in accordance with an exemplary embodiment of the present invention;

FIG. 13 illustrates a wager interface depicting an instructional gameplay screen in which a multiplier-based wagering event is visually represented in accordance with an exemplary embodiment of the present invention;

FIG. 14 illustrates a wager interface depicting a continuation of the gameplay scenario in accordance with an exemplary embodiment of the present invention;

FIG. 15 illustrates a wager interface depicting reward structures associated with wagering activity in accordance with an exemplary embodiment of the present invention;

FIG. 16 illustrates a wager interface depicting reward containers within the wagering environment in accordance with an exemplary embodiment of the present invention;

FIG. 17 illustrates a wager interface depicting the progression of rewards based on continued participation in wagering activity in accordance with an exemplary embodiment of the present invention;

FIG. 18 illustrates a wager interface that depicts a catalogue of available rewards within the wagering environment, in accordance with an exemplary embodiment of the present invention;

FIG. 19 illustrates a wager interface depicting a pre-event or pre-launch state of a wagering session in accordance with an exemplary embodiment of the present invention;

FIG. 20(A) illustrates a wager interface depicting an active wagering session following the countdown phase in accordance with an exemplary embodiment of the present invention;

FIG. 20(B) illustrates a wager interface during an active wagering session in accordance with an exemplary embodiment of the present invention;

FIG. 21(A) illustrates a wager interface after a crash event has occurred in accordance with an exemplary embodiment of the present invention;

FIG. 21(B) illustrates a wager interface showing the subsequent second-chance wagering stage in accordance with an exemplary embodiment of the present invention; and

FIG. 22 illustrates a wager interface during the second-chance progression stage in accordance with an exemplary embodiment of the present invention.

### DETAILED DESCRIPTION

### Definitions

The present disclosure is best understood with reference to the detailed figures and description set forth herein. Various embodiments have been discussed with reference to the figures. However, a person skilled in the art will readily appreciate that the detailed descriptions provided herein with respect to the figures are merely for explanatory purposes, as the methods and system may extend beyond the described embodiments. For instance, the teachings presented and the needs of a particular application may yield multiple alternatives and suitable approaches to implement the functionality of any detail described herein. Therefore, any approach may extend beyond certain implementation choices in the following embodiments.

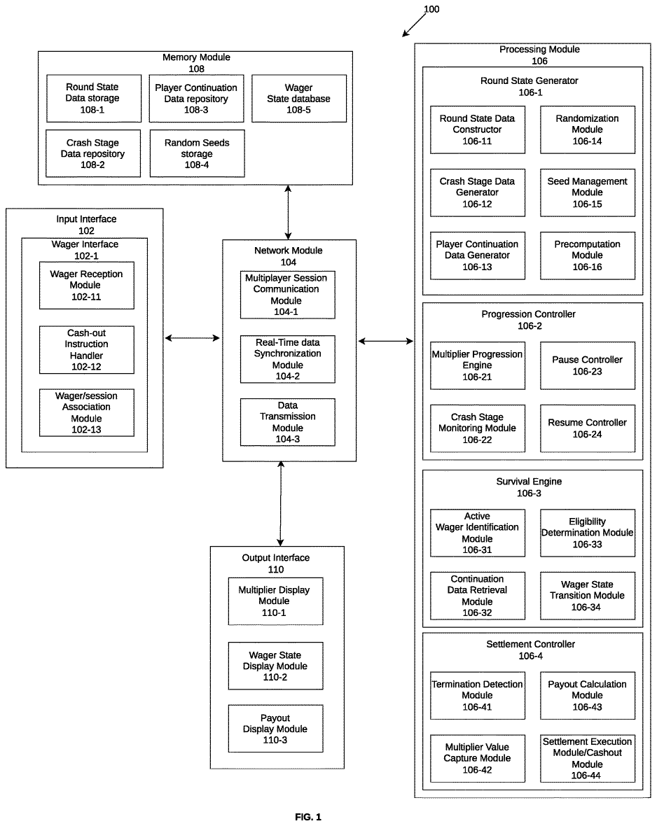

FIG. 1 illustrates a block diagram of a system 100 for managing staged continuation of wagers within a shared multiplayer game round in accordance with an exemplary embodiment of the present invention. The system 100 enables controlled progression of a shared multiplier while permitting independent continuation or termination of individual wagers at multiple crash stages based on player continuation data. The system 100 thereby introduces a staged continuation framework that departs from single-termination multiplier systems by enabling multiple continuation opportunities within a single round. The system 100 further supports configurable game profiles where an operator selects several crash stages, minimum and maximum multiplier bounds, and continuation difficulty curves.

In some examples, the crash stages described herein may more generally correspond to stage events, continuation checkpoints, termination events, elimination thresholds, or other progression events that occur during a shared multiplayer game round. Similarly, the disclosed multiplier may more generally correspond to a game parameter that progresses during the shared multiplayer game round and is evaluated at successive continuation checkpoints to determine whether individual wagers continue or terminate.

The system 100 may comprise an input interface 102, a network module 104, a processing module 106, a memory module 108, and an output interface 110. These components may communicate via wired or wireless channels, including communication buses, shared memory, APIs, message queues, or network links. In some implementations, communication may be event-driven, state-driven, or streaming-based.

The system 100 may be implemented using one or more computing devices, including centralized servers, distributed arrangements, cloud computing platforms, or hybrid architectures. In distributed implementations, functional modules of the processing module 106 may be deployed as independent microservices communicating via service interfaces. In certain scenarios, latency-sensitive components may be deployed closer to edge nodes, while computational or storage-intensive components may be hosted in cloud infrastructure. Such deployments may employ horizontal scaling behind load balancers to handle concurrent shared multiplayer rounds.

The input interface 102 is configured to receive user interactions and wagers from one or more players participating in the shared multiplayer game round. The input interface 102 may be implemented using hardware devices, software applications, or combinations thereof. The input interface 102 includes a wager interface 102-1 configured to enable one or more players to place wagers and interact with the multiplayer game round. The wager interface 102-1 may be implemented as a graphical user interface rendered on a smartphone, tablet, personal computer, gaming console, or other interactive device. The wager interface 102-1 adapts layout based on device, enabling simplified controls on mobile devices and ensuring consistent wager reception across the input interface 102.

In some implementations, the wager interface 102-1 may present dynamic graphical elements including multiplier displays, wager indicators, countdown timers, continuation prompts, and visual cues corresponding to crash stages. The wager interface 102-1 may further include animations, alerts, or haptic feedback to signal crash stage events or continuation opportunities. The wager interface 102-1 includes a wager reception module 102-11 configured to receive wagers for the shared multiplayer game round. The wagers may include fixed-value wagers, variable wagers, multiple concurrent wagers per player, and automated wagers generated via rule-based or algorithmic strategies. The wager reception module 102-11 enforces per-player limits on the maximum number of concurrent wagers within the input interface 102 to support responsible gaming.

The wager interface 102-1 further includes a cash-out instruction handler 102-12 configured to receive termination instructions. In certain scenarios, the handler may implement real-time, user-triggered cash-out, auto-cash-out thresholds, and conditional triggers based on multiplier value or elapsed time. The cash-out instruction handler 102-12 may timestamp requests to resolve race conditions with approaching crash stages, using server time as a reference for fairness. The wager interface 102-1 includes a wager/session association module 102-13 configured to associate each wager with a shared multiplayer round. The wager/session association module 102-13 may maintain mappings between player identifiers, wager identifiers, session identifiers, and round identifiers. In certain scenarios, the input interface 102 may include validation mechanisms such as wager verification, balance checks, fraud detection filters, and compliance controls.

The network module 104 facilitates communication between the components of system 100 and player devices. The network module 104 may support wired and wireless communication protocols, including TCP/IP, HTTP, WebSocket, gRPC, and real-time streaming protocols. The network module 104 may operate over one or more communication networks, including internet infrastructure, local and wide area networks, cellular networks (3G, 4G, 5G), and satellite or edge communication systems. The network module 104 may dynamically select between transport mechanisms based on client capabilities and network quality while preserving the timeliness of critical updates.

The network module 104 includes a multiplayer session communication module 104-1 configured to distribute game state information to multiple players in real time. The multiplayer session communication module 104-1 further communicates wager data and game state across multiple players, ensuring synchronized multiplayer interactions. The network module 104 further includes a real-time data synchronization module 104-2 configured to maintain consistency of multiplier progression and wager states across distributed clients. The synchronization may be achieved using timestamping, state reconciliation, and event broadcasting. The multiplayer session communication module 104-1 groups players into logical sessions based on round identifiers, and the real-time data synchronization module 104-2 attaches sequence numbers to outgoing messages for client resynchronization. The network module 104 also includes a data transmission module 104-3 configured to transmit round state data, continuation data, multiplier updates, and settlement outcomes. In some implementations, the network module 104 may include fault-tolerant mechanisms, redundancy protocols, and load-balancing techniques to ensure high availability and reliability.

The processing module 106 represents a computing subsystem responsible for executing game logic and managing staged continuation of wagers. The processing module 106 may include one or more processors, including CPUs, GPUs, or specialized hardware accelerators. The processing module 106 includes an internal task scheduling and load-balancing mechanism configured to dynamically allocate computational resources among a round state generator 106-1, a progression controller 106-2, a survival engine 106-3, and a settlement controller 106-4. Thereby ensuring consistent performance under high concurrency conditions in large-scale multiplayer environments.

The round state generator 106-1 is configured to generate and manage round state data before and during the shared multiplayer game round. The round state generator 106-1 includes a round state data constructor 106-11 configured to logically bind crash stage data and player continuation data into a structured dataset indexed by stage identifiers and player identifiers. The round state generator 106-1 includes a crash stage data generator 106-12 configured to generate an ordered sequence of crash multipliers. The crash multipliers define successive crash stages and may be generated using uniform distributions, non-uniform probability distributions, weighted randomization, and deterministic sequences. The crash stage data may define a fixed number of stages, dynamically determined stages, and layer-dependent stage configurations. The round state generator 106-1 further includes a player continuation data generator 106-13 configured to generate stage-specific continuation eligibility values for each player. These values determine whether the player proceeds to the next round based on factors such as prior performance or wagers. The continuation eligibility values may include binary continuation indicators, probability thresholds, and weighted continuation scores. This enables personalized, fair progression in multiplayer crash games, enhancing engagement by tailoring outcomes per player.

The round state generator 106-1 includes a randomization module 106-14 configured to generate random values used in crash stage generation and continuation determination. The randomization module 106-14 ensures unbiased, verifiable outcomes, preventing predictability in high-stakes gaming environments while complying with regulatory fairness standards. The round state generator 106-1 further includes a seed management module 106-15 configured to generate and store random seeds. The seeds enable deterministic reproduction of crash stage sequences and continuation outcomes. The seed management module 106-15 may be configured to associate each generated seed with a cryptographic hash stored in the memory module 108, enabling post-round verification and audit of generated outcomes without exposing the underlying seed values during gameplay. The round state generator 106-1 includes a precomputation module 106-16 configured to generate crash-stage data and continuation data before round initiation, thereby minimizing real-time latency. In one scenario, the player continuation data may be generated independently of crash-stage data, thereby ensuring statistical independence between crash events and continuation eligibility. The round state generator 106-1 collectively ensures a robust, fair, and efficient round state generation process in crash-style games, balancing randomness, personalization, and verifiability.

The progression controller 106-2 is a core component that governs the progression of a game multiplier based on crash stage data. The progression controller 106-2 orchestrates the real-time advancement of the game multiplier during each crash game round, leveraging precomputed crash stage data from precomputation module 106-16. This ensures smooth, predictable escalation until a crash point is triggered, creating tension and strategic cash-out opportunities for players. The progression controller 106-2 includes synchronization checkpoints configured to align the multiplier progression state with the persisted round state data, thereby enabling recovery and continuation of gameplay in the event of transient system interruptions.

The progression controller 106-2 includes a multiplier progression engine 106-21 configured to increment multiplier values over time according to linear, exponential, or custom progression models. The multiplier progression engine 106-21 engine applies algorithms, such as linear, exponential, or custom. This dynamically escalates the multiplier, heightening player anticipation and strategic depth in crash rounds. The progression controller 106-2 includes a crash stage monitoring module 106-22 configured to detect when the multiplier reaches defined crash stages. The crash stage monitoring module 106-22 module continuously compares the live multiplier against precomputed crash stage data. This triggers alerts at predefined thresholds. It ensures precise synchronization among players, preventing discrepancies in multiplayer environments and enabling timely interventions to ensure fair play. The crash stage monitoring module 106-22 includes precision threshold logic configured to account for floating-point deviations in multiplier calculations, thereby ensuring accurate detection of crash stage triggers across distributed systems. The progression controller 106-2 further includes a pause controller 106-23 configured to pause multiplier progression at crash stages to allow evaluation of wagers. Upon detection by the crash stage monitoring module 106-22, the pause controller 106-23 halts increment instantly, providing a brief window for wager settlements, player cash-outs, or continuation eligibility. This maintains game integrity by decoupling progression from real-time betting outcomes. The progression controller 106-2 includes a resume controller 106-24 configured to resume multiplier progression following evaluation. After pause resolution, the resume controller 106-24 seamlessly restarts increments from the paused value, using crash stage data to guide the next phase. In an exemplary scenario, pause duration may be fixed, dynamic, or dependent on system latency or player interaction windows. The survival engine 106-3 is configured to evaluate continuation eligibility of wagers using player continuation data, and to evaluate active wagers using the player continuation data to determine whether each wager continues or terminates in response to the multiplier reaching a crash stage. The survival engine 106-3 includes an active wager identification module 106-31 configured to scan and identify all currently active wagers across multiplayer sessions during crash stages. active wager identification module 106-31 maintains real-time tracking of player bets linked to the current round, filtering out cashed-out or terminated wagers to create a precise evaluation list for continuation eligibility processing. The survival engine 106-3 includes a continuation data retrieval module 106-32 configured to fetch player continuation data. This module retrieves stage-specific continuation eligibility values, synchronized with the current crash-stage data, ensuring that all survival decisions reference the most relevant precomputed and real-time parameters.

The survival engine 106-3 further includes an eligibility determination module 106-33 configured to determine continuation using: stage-specific probability values, random seeds, precomputed data, and runtime evaluation. The eligibility determination module 106-33 may incorporate deterministic mapping functions that combine stored seed values with wager-specific identifiers to ensure reproducible yet independent continuation outcomes for each wager. The survival engine 106-3 also includes a wager state transition module 106-34 configured to execute state changes for surviving or terminated wagers post-eligibility determination. It updates the wager status, notifies the pause controller 106-23 and settlement controller 106-4, and propagates changes via network module 104-1 to synchronize the multiplayer state, enabling seamless progression to the next crash stage or payout processing. The survival engine 106-3 provides a logical, sequential pipeline for evaluating wagers against crash stages using player continuation data, ensuring scalable and fair multiplayer crash game mechanics.

The survival engine 106-3 may operate using independent evaluation per wager, batch evaluation, and parallel processing. The survival engine 106-3 includes load distribution logic configured to partition active wagers into evaluation groups processed across multiple threads or processing nodes, thereby ensuring scalability for thousands of concurrent players. In an exemplary scenario, continuation eligibility may depend on player-specific parameters, wager-specific attributes, historical outcomes, and configurable system rules. The settlement controller 106-4 is configured to determine settlement outcomes. The settlement controller 106-4 may calculate payouts based on the multiplier value at termination, wager amount, bonus conditions, and promotional modifiers. The settlement controller 106-4 may further update player accounts, record results, and trigger external systems such as payment processors.

The settlement controller 106-4 includes a termination detection module 106-41 configured to monitor and confirm wager termination signals from the survival engine 106-3 and crash stage monitoring 106-22. The termination detection module 106-41 validates termination triggers and queuing confirmed cases for settlement while filtering out active/surviving wagers. This enables precise isolation of resolved bets in the multiplayer environment. The termination detection module 106-41 may include conflict resolution logic configured to prioritize termination signals originating from cash-out instructions over system-triggered crash terminations when occurring within a defined temporal proximity window. The settlement controller 106-4 includes a multiplier value capture module 106-42 configured to snapshot the exact multiplier value at the termination point. The multiplier value capture module 106-42, timestamped with the precise moment of termination detection 106-41, retrieves the frozen multiplier value and provides an immutable reference for fair payout calculations.

The settlement controller 106-4 further includes a payout calculation module 106-43 configured to calculate payouts based on the multiplier value at termination, wager amount, bonus conditions, and promotional modifiers. Using captured data from 106-42, wager details, and modifiers, the payout calculation module 106-43 computes final returns. The settlement controller 106-4 includes a settlement execution module/cashout handler 106-44 configured to update player accounts, record results, and trigger external systems such as payment processors. This finalizes transactions atomically, crediting balances, logging outcomes to audit trails, notifying, and interfacing with payment gateways, while the main game round persists uninterrupted for continuing players. The settlement execution module 106-44 includes transaction handling mechanisms configured to prevent duplicate settlement processing in the event of network retries or system failures.

The memory module 108 serves as a centralized, secure repository that stores data, including: round state data, crash stage data, player continuation data, random seeds, multiplier history, and wager states. The memory module 108 may support audit logging, replay functionality, and regulatory compliance. The memory module 108 includes a round state data storage 108-1 configured to persist comprehensive round state information, such as current stage, active players, global timestamps, and progression snapshots. This enables seamless round resumption after pauses and supports batch evaluations in the survival engine 106-3, and provides historical context for multiplier history tracking, facilitating analytics and player session continuity across multiplayer crash games. The memory module 108 also includes a crash stage data repository 108-2 configured to store precomputed crash stage data, including sequences of crash points, multipliers, and associated continuation data. The crash stage data repository 108-2 ensures scalability and verifiability while supporting audit logging for regulatory oversight in high-volume gaming platforms.

The memory module 108 may include a player continuation data repository 108-3 configured to store stage-specific continuation eligibility values for each player and associated wagers. The player continuation data repository 108-3 may organize data using multi-level indexing structures based on player identifiers, wager identifiers, and crash stage identifiers, thereby enabling the continuation data retrieval module 106-32 to retrieve continuation parameters during real-time evaluation efficiently. In an exemplary scenario, the player continuation data repository 108-3 may support rapid lookup operations during pause intervals at crash stages, allowing the survival engine 106-3 to evaluate thousands of wagers concurrently without latency bottlenecks. The memory module 108 may include a random seed storage 108-4 configured to securely store one or more random seeds generated by the seed management module 106-15. The random seeds storage 108-4 may maintain associations between stored seeds and corresponding round identifiers, crash stage sequences, and continuation determination processes. The random seeds storage may further incorporate cryptographic protection mechanisms, such as hashing or encryption, to prevent unauthorized access while enabling deterministic reproduction of outcomes for audit and verification purposes. In an exemplary scenario, upon completion of a multiplayer round, the stored seeds may be used to reconstruct crash-stage data and continuation decisions, thereby validating fairness and regulatory compliance.

The memory module 108 may include a wager state database 108-5 configured to maintain real-time and historical state information for each wager, where each wager is associated with a state selected from active, continuation, terminated, or settled. The wager state database 108-5 may implement indexed and transactional data structures to support atomic updates initiated by the wager state transition module 106-34 and settlement execution module 106-44. The wager state database 108-5 may further maintain time-stamped state transition logs, enabling traceability of wager lifecycles across multiple crash stages. In an exemplary scenario, the wager state database 108-5 may support concurrent read and write operations across distributed processing nodes, ensuring consistent, synchronized wager states across multiplayer sessions while minimizing contention and latency.

The output interface 110 presents game information to players. The output interface 110 may include real-time displays of multiplier progression, wager states, continuation events, and settlement outcomes. The output interface 110 includes real-time displays of multiplier progression, wager states, continuation events, and settlement outcomes, ensuring that all players see identical game states and fostering trust and competitive excitement during shared rounds. The output interface 110 includes a multiplier display module 110-1 configured to display the progression of the game multiplier. This multiplier display module 110-1 renders live, animated charts showing the multiplier's ascent with smooth curves that match progression models, highlighting crash-stage thresholds with color-coded warnings and pause/resume indicators to help players time cash-outs strategically.

The output interface 110 includes a wager state display module 110-2 configured to display wager states. The wager state display module 110-2 provides per-player dashboards showing individual bet status icons, for example, green “active”, yellow “continuation”, red “terminated”, blue “settled”, potential returns, and real-time transitions triggered by survival evaluations. This enables players to track personal and peer wager progression across crash stages. The output interface 110 includes a payout display module 110-3 configured to display settlement outcomes and payouts. The payout display module 110-3 showcases results with celebratory animations for wins, detailed breakdowns, and transaction confirmations, while also featuring leaderboards of top payouts and round statistics to enhance social competition and replay value. The output interface 110 may include synchronization feedback mechanisms configured to confirm alignment between client-side rendered states and server-side authoritative game state, thereby ensuring consistency and preventing visual discrepancies across multiplayer participants.

During operation, wagers are received and associated with a shared multiplayer round. The round state generator 106-1 generates crash stage data and continuation data. The progression controller 106-2 initiates multiplier progression. At each crash stage, the multiplier is paused, and the survival engine 106-3 evaluates continuation eligibility. Wagers are independently continued or terminated, and the round continues for eligible wagers. The settlement controller 106-4 calculates outcomes for terminated wagers and updates system records. The system supports multiple embodiments, including configurable numbers of crash stages, randomized or deterministic continuation logic, and hybrid evaluation models. The system 100 includes state checkpointing at each crash stage, in which intermediate round states are persisted in memory module 108 to enable replay, auditing, or recovery in the event of interruptions.

In one scenario, continuation eligibility is probabilistic and varies per stage. In another scenario, continuation eligibility is precomputed and verified using stored seeds. In a further scenario, hybrid models combine precomputed and runtime evaluation. In large-scale deployments, distributed processing enables thousands of concurrent players. In audit scenarios, stored seeds reproduce outcomes deterministically. The hybrid evaluation models may dynamically switch between precomputed and runtime evaluation modes based on system load, latency thresholds, or regulatory requirements, thereby optimizing both performance and fairness assurance.

FIG. 2 illustrates a structured representation of round state data 200 in accordance with an exemplary embodiment of the present invention. The round state data 200 is configured for managing the staged continuation of wagers within a shared multiplayer game round. The round state data 200 represents a composite data structure generated by the round state generator and used by other system components to coordinate multiplier progression and continuation eligibility of wagers. The round state data 200 is generated before initiation of the shared multiplayer game round and defines parameters governing both shared progression behavior and individual wager outcomes. The round state data 200 may be instantiated as a version-controlled data object, where each instance is uniquely associated with a round identifier and includes integrity verification metadata to ensure consistency across distributed processing components during gameplay.

The round state data 200 comprises a crash stage data 202 and a player continuation data 204 to enable efficient cross-referencing during real-time evaluation by the survival engine. The crash stage data 202 and the player continuation data 204 collectively enable operation of the system in which a shared multiplayer game round is maintained. At the same time, individual wagers independently continue or terminate at different crash stages.

The crash stage data 202 comprises an ordered sequence of crash multipliers corresponding to successive crash stages occurring during the progression of a multiplier. Each crash multiplier defines a stage threshold at which evaluation of wagers is performed. The ordered sequence ensures that crash stages occur in a defined progression sequence, enabling staged evaluation of wagers as the multiplier increases. The ordered sequence is stored as an indexed array or time-ordered list structure, enabling constant-time access to the next crash stage during multiplier progression by the progression controller.

In certain scenarios, the crash stage data 202 defines two or more crash multipliers, thereby enabling multiple successive crash stages within a single shared multiplayer game round. The crash stage data 202 may be generated using a randomization process, deterministic configuration, or a hybrid approach combining predefined rules with random generation. The crash stage data 202 may further include stage identifiers, ordering indices, or timing attributes associated with each crash stage. The crash stage data 202 includes stage transition metadata defining pause triggers and evaluation checkpoints, enabling seamless coordination with the pause controller and resume controller during multiplier progression.

The crash stage data 202 is shared across all wagers participating in the shared multiplayer game round, such that each wager is subject to evaluation at the same crash stages. The shared crash stage data 202 is broadcast and cached across distributed nodes via the network module to ensure synchronized access and eliminate discrepancies in multiplayer environments. This shared structure enables a common multiplier progression framework while allowing independent outcomes for individual wagers.

The player continuation data 204 comprises stage-specific continuation eligibility values associated with wagers. The player continuation data 204 defines whether each wager is eligible to continue or is to be terminated at each crash stage. The continuation eligibility values may include continuation indicators, probability values, threshold conditions, or other data used to determine continuation eligibility. The player continuation data 204 includes wager-specific identifiers and stage mappings enabling direct lookup of eligibility values without requiring precomputation during runtime evaluation.

In one exemplary scenario, the player continuation data 204 includes continuation indicators that explicitly specify whether a wager is eligible for continuation at a given crash stage. In other scenario, the player continuation data 204 includes probability values that are used in conjunction with randomization processes to determine continuation eligibility. The continuation eligibility may be determined using stage-specific probability values, and in some implementations, may involve one or more random seeds. The probability-based continuation determination utilizes deterministic functions combining stored random seeds with wager identifiers to ensure reproducibility and fairness while maintaining independence across wagers.

The player continuation data 204 may be generated independently from the crash stage data 202. This separation enables independent determination of continuation eligibility without altering the shared crash stage progression. The generation of player continuation data 204 may be triggered at runtime based on configurable system parameters, enabling adaptive gameplay behavior while maintaining consistency with precomputed round state constraints. In certain implementations, the player continuation data 204 may be generated before initiation of the shared multiplayer game round, while in other implementations, it may be generated dynamically during progression of the multiplayer.

The player continuation data 204 may be structured as a mapping between wager identifiers and crash stage identifiers, such that continuation eligibility values can be retrieved for each wager at each crash stage. In alternative implementations, the player continuation data 204 may be organized as matrices, lookup tables, or indexed data structures to support efficient evaluation by the survival engine 106-3.

The round state data 200 may further include implicit or explicit associations between the crash stage data 202 and the player continuation data 204, enabling retrieval of stage-specific continuation eligibility values corresponding to each crash stage during multiplier progression. These associations allow the system to evaluate wagers at each crash stage using the appropriate continuation eligibility values. Such associations may be implemented as pointer references or relational mappings within the round state data structure, reducing computational overhead during linkage resolution at runtime.

In operation, the round state data 200 functions as a foundational data structure for the shared multiplayer game round. The crash stage data 202 defines successive crash stages during multiplier progression, while the player continuation data 204 defines continuation eligibility of wagers at each of those stages. By generating the round state data 200 prior to initiation of the shared multiplayer game round, the system enables coordinated multiplier progression and staged evaluation of wagers, thereby supporting independent continuation and termination outcomes within a shared gameplay environment. The round state data 200 may be persistently stored in the memory module 108 with checkpointing at each crash stage, enabling replay, audit verification, and recovery of the game state in case of system interruptions or regulatory review scenarios.

FIG. 3 illustrates a multiplier progression and crash stage control architecture 300 in accordance with an exemplary embodiment of the present invention. The multiplier progression and crash stage control architecture 300 is configured to implement the operation of the progression controller for managing the progression of a multiplier within the shared multiplayer game round. The architecture 300 expands the functionality of the progression controller by illustrating the sequence of operations through which multiplier progression is initiated, controlled, paused at crash stages, and resumed following evaluation of wagers. The multiplier progression and crash stage control architecture 300 operates as a deterministic execution pipeline synchronized with precomputed crash stage data, ensuring consistent multiplier progression behavior across all participants in the shared multiplayer environment.

The multiplier progression and crash stage control architecture 300 comprises a multiplier progression engine 302, a crash stage monitoring module 304, a pause controller 306, a survival engine 308, and a resume controller 310. These components operate in coordination using crash stage data generated by the round state generator prior to initiation of the shared multiplayer game round.

The multiplier progression engine 302 is configured to initiate and control the progression of the multiplier using the crash stage data. The multiplier progression engine 302 generates a multiplier value that increases over time in accordance with predefined progression rules. The progression may be continuous, discrete, or based on dynamically adjustable parameters. In certain scenario. the multiplier progression engine 302 initializes the multiplier at a starting value and incrementally increases the multiplier throughout the shared multiplayer game round. The multiplier progression engine 302 maintains an internal progression state register that stores the current multiplier value, progression rate, and stage index, enabling precise synchronization with crash stage thresholds and ensuring consistent recovery during transient execution interruptions.

The crash stage monitoring module 304 is configured to monitor the multiplier value as it progresses and detect when the multiplier reaches a crash stage defined in the crash stage data. The crash stage monitoring module 304 compares the current multiplier value against the ordered sequence of crash multipliers and identifies the corresponding crash stage. Upon detecting a crash stage, the crash stage monitoring module 304 triggers the evaluation of wagers. The crash stage monitoring module 304 incorporates threshold comparison logic with precision control to account for computational rounding, thereby ensuring accurate and consistent detection of crash stages across distributed system environments.

The pause controller 306 is configured to temporarily pause multiplier progression at a crash stage before evaluation of wagers. The pause controller 306 may suspend the multiplier progression engine 302 or regulate the progression rate to create a defined evaluation interval. The pause may be implemented as a complete halt, a controlled delay, or a synchronization period to allow processing of continuation eligibility across all active wagers. The pause controller 306 enforces a synchronized evaluation window across all nodes, ensuring that no multiplier advancement occurs until the survival evaluation is complete, thereby preserving fairness and preventing race conditions in wager processing.

The survival engine 308 is configured to evaluate active wagers using player continuation data to determine whether each wager continues or terminates responsive to the multiplier reaching the crash stage. The survival engine 308 retrieves stage-specific continuation eligibility values and determines continuation eligibility for each wager. The survival engine 308 executes evaluation using parallelized processing pipelines that apply deterministic continuation logic per wager, ensuring scalability for large numbers of concurrent wagers while maintaining outcome reproducibility based on precomputed data and associated seeds. Wagers determined to be ineligible for continuation are transitioned into a terminated state, while wagers determined to be eligible are maintained in a continuation state.

The resume controller 310 is configured to resume multiplier progression after continuation eligibility of wagers is determined. The resume controller 310 reactivates the multiplier progression engine 302 to continue progression toward a subsequent crash stage. Only wagers maintained in the continuation state remain active during subsequent progression. The resume controller 310 validates completion of all wager state transitions before reactivation, ensuring that only correctly updated continuation states are propagated into subsequent multiplier progression cycles.

The progression controller 300 maintains wagers determined to continue as the same original wagers within the shared multiplayer game round, while wagers that are terminated are resolved independently. The architecture 300 therefore enables a hybrid operational model in which multiplier progression is shared across all wagers, while continuation and termination outcomes are independently determined. The hybrid operational model enforces logical isolation between continuation processing and settlement execution, allowing terminated wagers to be processed without interrupting ongoing multiplier progression for continuing wagers. Wagers determined to continue may remain active within the shared multiplayer game round as the same original wagers without requiring re-entry, rebuy, replacement, duplication, or placement of additional wagers.

In some implementations, the multiplier progression and crash stage control architecture 300 may further support asynchronous termination events, including termination of wagers responsive to cash-out instructions received during multiplier progression. Asynchronous termination events are captured via real-time multiplier snapshots synchronized with the progression state register, ensuring accurate and verifiable settlement values regardless of crash-stage boundaries. Such termination events may occur independently of crash stage detection and may result in settlement based on the multiplier value at the time of termination.

In operation, the multiplier progression engine 302 initiates progression of the multiplier using crash stage data generated before initiation of the shared multiplayer game round. The crash stage monitoring module 304 detects successive crash stages as the multiplier increases. At each crash stage, the pause controller 306 temporarily pauses progression, and the survival engine 308 evaluates continuation eligibility of wagers using player continuation data. Following evaluation, the resume controller 310 resumes multiplier progression for wagers determined to continue. This sequence repeats for successive crash stages, thereby enabling staged continuation of wagers within the shared multiplayer game round. The operational sequence is executed as a repeatable state-transition cycle, with each cycle corresponding to a crash stage and recorded in system logs to enable deterministic replay, audit validation, and system debugging.

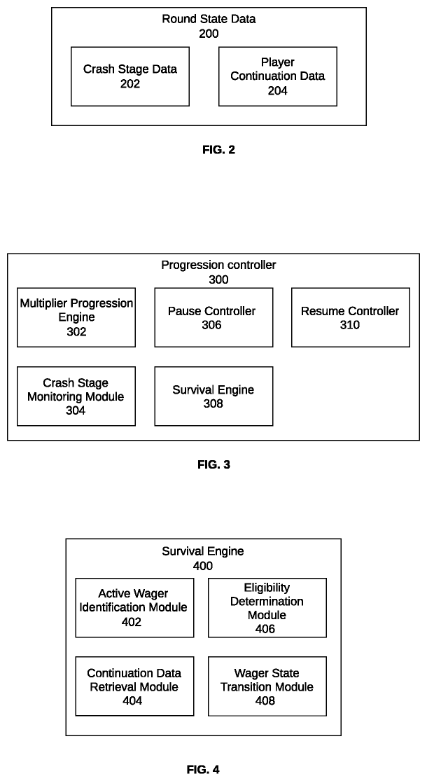

FIG. 4 illustrates a continuation eligibility evaluation architecture 400 in accordance with an exemplary embodiment of the present invention. The continuation eligibility evaluation architecture 400 is configured to implement the survival engine's operation for evaluating active wagers within the shared multiplayer game round. The architecture 400 expands the functionality of the survival engine by illustrating the sequence of operations through which active wagers are identified, continuation eligibility is determined using player continuation data, and wagers are transitioned into continuation or terminated states responsive to a crash stage. The architecture 400 operates as a deterministic, stage-synchronized evaluation pipeline that is triggered at each crash stage, ensuring uniform execution of continuation logic across all active wagers.

The continuation eligibility evaluation architecture 400 comprises an active wager identification module 402, a continuation data retrieval module 404, an eligibility determination module 406, and a wager state transition module 408. These components operate in coordination using round state data generated by the round state generator before initiation of the shared multiplayer game round.

The active wager identification module 402 is configured to identify wagers that are in an active state at the time of evaluation. The active wagers correspond to wagers that have not yet been terminated or settled and are eligible for evaluation at a crash stage. The active wager identification module 402 may retrieve a set of active wagers from maintained wager state data and prepare the identified wagers for continuation eligibility evaluation. The active wager identification module 402 performs indexed queries on the wager state database to filter wagers based on current state and stage alignment, ensuring that only valid and relevant wagers are included in the evaluation set for the current crash stage. The identification process utilizes indexed access into the wager state database based on wager state flags and current stage identifiers, ensuring that only valid, non-terminated wagers aligned with the current crash stage are included in the evaluation set.

The continuation data retrieval module 404 is configured to retrieve stage-specific continuation eligibility values from the player continuation data included within the round state data. The continuation data retrieval module 404 accesses continuation indicators, probability values, or other eligibility parameters corresponding to each identified active wager at the current crash stage. The continuation data retrieval module 404 utilizes direct indexed access mappings between wager identifiers and stage identifiers, enabling low-latency retrieval of continuation parameters during time-sensitive evaluation windows. The retrieved continuation eligibility values are associated with both the wager and the crash stage at which evaluation is being performed.

The eligibility determination module 406 is configured to determine continuation eligibility of each active wager using the retrieved player continuation data. In certain embodiments, the eligibility determination module 406 determines continuation eligibility by retrieving continuation indicators that directly specify whether a wager is eligible to continue. The eligibility determination module 406 applies deterministic evaluation functions that combine retrieved continuation data with stored random seeds and wager-specific identifiers, ensuring outcome reproducibility while maintaining statistical independence across wagers. In some implementations, the eligibility determination module 406 determines continuation eligibility using stage-specific probability values, which may be evaluated using one or more random seeds. The eligibility determination may be performed using precomputed continuation data, runtime evaluation, or a hybrid approach combining both precomputed and dynamically generated values.

The eligibility determination module 406 evaluates each active wager independently, thereby enabling different wagers within the shared multiplayer game round to have distinct continuation or termination outcomes at the same crash stage. This independent evaluation ensures that while the multiplier progression is shared, the continuation behavior of wagers remains individualized. The independent evaluation is executed using parallel processing pipelines, where subsets of active wagers are processed concurrently and synchronized upon completion to maintain overall system consistency.

The wager state transition module 408 is configured to transition wagers based on the determined continuation eligibility. Wagers determined ineligible for continuation are transitioned to a terminated state. In contrast, wagers determined to be eligible for continuation are maintained in a continuation state, allowing progression to a subsequent crash stage. The wager state transition module 408 may update wager state data structures to reflect the current state of each wager. The wager state transition module 408 enforces atomic state updates with transactional integrity, ensuring that each wager state transition is completed without partial updates and is consistently reflected across all dependent system components.

The continuation eligibility evaluation architecture 400 produces output comprising continuation-state wagers and terminated-state wagers. The continuation state wagers remain active for subsequent multiplier progression and evaluation at future crash stages. In contrast, the terminated state wagers are removed from further progression and may be processed for settlement. The output is structured as categorized data sets indexed by wager state, enabling direct consumption by the progression controller for continued gameplay and by the settlement controller for payout processing.

In some implementations, the continuation eligibility evaluation may be synchronized with a pause in multiplier progression at a crash stage, such that all active wagers are evaluated before progression resumes. In other implementations, evaluation may be performed in parallel or using distributed processing techniques to support large numbers of concurrent wagers.

In operation, the active wager identification module 402 identifies active wagers at a crash stage, the continuation data retrieval module 404 retrieves corresponding stage-specific continuation eligibility values from the round state data, and the eligibility determination module 406 determines continuation eligibility for each wager using the player continuation data. The wager state transition module 408 then transitions wagers into continuation or terminated states based on the determination. This process enables the staged continuation of wagers within the shared multiplayer game round while maintaining independent outcomes for individual wagers.

FIG. 5 illustrates a wager state transition model 500 in accordance with an exemplary embodiment of the present invention. The wager state transition model 500 is configured to manage lifecycle states of wagers within the shared multiplayer game round. The wager state transition model 500 supports the operation of the system in which each wager is associated with a wager state selected from active, continuation, terminated, or settled, and transitions between these states occur in response to continuation eligibility evaluation and settlement determination. The wager state transition model 500 further defines a structured state machine with explicitly governed transition conditions, ensuring that each wager occupies only one valid state at any point in time during execution of the shared multiplayer game round.

The wager state transition model 500 comprises an active state 502, a continuation state 504, a terminated state 506, and a settled state 508. Each wager is associated with one of the wager states at any given time during the operation of the shared multiplayer game round. Each state is represented by a state identifier and associated metadata stored in the wager state database, enabling efficient tracking, querying, and updating of wager lifecycle states during real-time processing.

The active state 502 corresponds to a state in which a wager has been received for participation in the shared multiplayer game round and is pending evaluation at a crash stage. Wagers in the active state 502 are subject to evaluation by the survival engine using player continuation data when the multiplier reaches a crash stage. The active state 502 is initialized upon successful association of a wager with the shared multiplayer game round and is maintained until the first continuation eligibility evaluation event is triggered.

The continuation state 504 corresponds to a state in which a wager has been evaluated at a crash stage and determined to be eligible for continuation. Wagers in the continuation state 504 remain active during the shared multiplayer game round and are eligible to progress to subsequent crash stages. The continuation state 504 allows wagers to persist across successive crash stages based on continuation-eligibility determinations. The continuation state 504 is updated at each successive crash stage based on repeated eligibility evaluations, thereby enabling iterative state persistence across multiple evaluation cycles within the same game round.

The terminated state 506 corresponds to a state in which a wager has been determined to be ineligible for continuation at a crash stage or has otherwise reached a termination point. Wagers transitioned into the terminated state 506 are removed from further multiplier progression and are no longer eligible for continuation within the shared multiplayer game round. The terminated state 506 represents an irreversible state transition within the state model, ensuring that once a wager is marked as terminated, it is excluded from subsequent continuation evaluations and multiplier progression cycles.

The settled state 508 corresponds to a state in which a settlement outcome has been determined for a wager. The settlement outcome is based on a multiplier value at a termination point responsive to termination of the wager. The termination point may correspond to a crash stage or a cash-out instruction received for the wager during multiplier progression. The settled state 508 includes associated settlement metadata, including payout values, timestamps, and transaction identifiers, enabling traceability and auditability of completed wager outcomes.

The wager state transition model 500 defines transitions between the wager states based on continuation eligibility evaluation and settlement determination. A wager transitions from the active state 502 to the continuation state 504 when the survival engine determines that the wager is eligible for continuation at a crash stage. A wager transitions from the active state 502 to the terminated state 506 when the survival engine determines that the wager is ineligible for continuation. Each transition is triggered by explicit evaluation outputs from the survival engine, ensuring that state changes are directly linked to continuation-eligibility determinations derived from player continuation data.

A wager in the continuation state 504 may transition to the terminated state 506 at a subsequent crash stage if the survival engine determines that the wager is no longer eligible for continuation based on stage-specific continuation eligibility values. Thus, wagers may remain in the continuation state 504 across multiple crash stages until a termination condition is met. This transition supports stage-wise re-evaluation, in which continuation eligibility is reassessed at each crash stage using updated stage-specific parameters without altering previously evaluated outcomes.

A wager in any of the active state 502, continuation state 504, or terminated state 506 may transition to the settled state 508 when the settlement controller determines a settlement outcome. In certain scenarios, wagers may be settled responsive to a cash-out instruction, in which case the settlement controller calculates payouts based on the multiplier value at the time of termination associated with the cash-out instruction. The transition into the settled state 508 is executed as an atomic operation by the settlement controller, ensuring that payout computation, account update, and state transition occur as a single consistent transaction.

The survival engine and the settlement controller manage the wager state transitions. The survival engine controls transitions among the active state 502, the continuation state 504, and the terminated state 506 based on the evaluation of continuation eligibility using player continuation data. The settlement controller controls transitions into the settled state 508 and determines settlement outcomes based on the multiplier value at the termination point. The coordination between the survival engine 106-3 and the settlement controller is enforced through synchronized signaling mechanisms, ensuring that no conflicting state transitions occur during concurrent evaluation and settlement operations.

In operation, the wager state transition model 500 enables independent lifecycle management of wagers within the shared multiplayer game round. While the multiplier progression and crash stages are shared across all wagers, each wager progresses through the defined states based on individual continuation eligibility determinations and termination events. This state-based model supports staged continuation of wagers and independent resolution of terminated wagers within the shared multiplayer game round. The state transition model further supports audit logging and deterministic replay by recording each state transition event with its associated stage identifiers and timestamps, thereby enabling verification of the wager lifecycle progression throughout the entire game round.

FIG. 6 illustrates a randomization and seed-based determination architecture 600 in accordance with an exemplary embodiment of the present invention. The randomization and seed-based determination architecture 600 is configured to support the generation of crash stage data and the determination of continuation eligibility within the shared multiplayer game round. The architecture 600 expands the operation of randomization processes associated with the round state generator and the survival engine. It provides mechanisms for reproducible and auditable determination of crash stages and continuation eligibility values. The architecture 600 further establishes a controlled randomization framework in which all probabilistic outcomes are derived from traceable seed inputs, thereby ensuring both fairness and deterministic verifiability of game results.

The randomization and seed-based determination architecture 600 comprises a randomization module 602 and a seed management module 604. The randomization module 602 and the seed management module 604 operate in coordination with the round state generator and the survival engine to generate crash-stage data and player continuation data through randomization processes.

The randomization module 602 is configured to generate one or more random seeds used in determining crash stage data and continuation eligibility. The random seeds may be generated using pseudo-random number generators, cryptographic random number generators, hardware-based entropy sources, or combinations thereof. In certain scenarios, the randomization module 602 generates independent random seeds for different aspects of the shared multiplayer game round, including separate seeds for crash-stage data generation and player-continuation data generation. This separation ensures statistical independence between crash-stage progression and continuation-eligibility determination, preventing correlated outcomes. In certain scenarios, the crash stage data and the player continuation data are generated using independent random seeds or independent randomization processes, such that continuation eligibility is decoupled from crash stage occurrence. This separation ensures that continuation outcomes are not derivable solely from crash stage progression, thereby enhancing unpredictability and system integrity.

In another scenario, one or more random seeds are used as a unified deterministic input framework for both crash-stage data generation and continuation-eligibility determination. The first transformation function may be applied to one or more random seeds to generate the ordered sequence of crash multipliers. In contrast, a second transformation function may be applied to the same or a different set of random seeds to derive stage-specific continuation eligibility values. In some implementations, both crash stage data and player continuation data are derived from a common seed source using independent transformation mappings, thereby ensuring functional independence while preserving deterministic reproducibility. This unified seed-based framework enables the complete reconstruction of multiplier progression and continuation outcomes for any shared multiplayer game round using stored seeds and associated parameters

The seed management module 604 is configured to store one or more random seeds in a memory module to enable the reproduction of continuation determinations and the generation of crash stages. The stored seeds may be associated with identifiers corresponding to a shared multiplayer game round, wagers, or crash stages. The seed management module 604 may store additional parameters, including sequence indices, timestamps, or configuration values used in conjunction with the random seeds. The seed management module 604 further organizes stored seeds using indexed data structures, enabling efficient retrieval based on round identifiers and stage indices during replay or audit operations.

The round state generator uses the random seeds generated by the randomization module 602 to generate crash stage data. In certain scenarios, the crash stage data comprises an ordered sequence of crash multipliers generated using one or more random seeds. The use of random seeds ensures variability in crash stage sequences across different multiplayer game rounds while allowing reproducibility when the same seeds are used. The round state generator applies deterministic transformation functions to the seeds to derive an ordered sequence of crash multipliers, ensuring that identical seed inputs always produce identical crash-stage sequences.

The survival engine further uses the random seeds to determine continuation eligibility. In a certain scenario, the player continuation data comprises stage-specific probability values, and the survival engine determines continuation eligibility using one or more random seeds. The randomization module 602 may generate random values based on the stored seeds, and such random values may be compared with probability thresholds to determine whether a wager is eligible for continuation at a crash stage. The comparison process is executed using deterministic evaluation logic, in which generated random values are mapped to predefined probability ranges to produce consistent continuation outcomes for identical inputs.

In some implementations, the player continuation data is generated independently from the crash stage data using separate random seeds. In other implementations, a shared set of seeds may be used with different transformation functions to derive both crash-stage data and continuation-eligibility values. When shared seeds are used, distinct transformation algorithms are applied to ensure that the derived outputs for crash stages and continuation eligibility remain functionally independent, even though they originate from the same seed source.

The seed management module 604 enables reproducible outcomes by storing one or more random seeds and associated parameters in the memory module. The stored seeds may be retrieved to reconstruct crash-stage data and continuation-eligibility determinations for replay, verification, auditing, or regulatory compliance purposes. In certain scenarios, the seed management module 604 supports deterministic regeneration of round state data using stored seeds and defined algorithms. The reconstruction process re-executes the same deterministic functions used during the initial generation, thereby ensuring exact replication of crash-stage sequences and continuation-eligibility outcomes.

In some implementations, the randomization module 602 generates one or more random seeds, and the seed management module 604 stores the generated seeds in the memory module. The round state generator uses the stored seeds to generate crash-stage data and the survival engine to determine continuation eligibility. This architecture enables probabilistic determination of crash stages and continuation eligibility while maintaining the ability to reproduce and verify outcomes within the shared multiplayer game round. The operational flow ensures that all randomization-dependent processes are traceable to stored seed values, thereby enabling end-to-end auditability and eliminating ambiguity in outcome generation across the system.

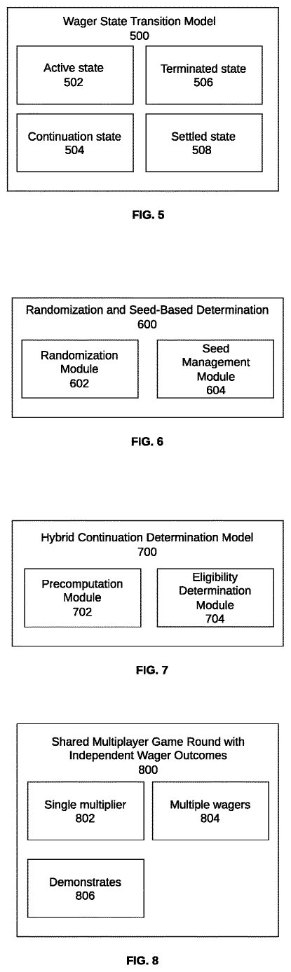

FIG. 7 illustrates a hybrid continuation determination model 700 in accordance with an exemplary embodiment of the present invention. The hybrid continuation determination model 700 is configured to determine continuation eligibility using both precomputed continuation data and runtime evaluation during the shared multiplayer game round. The hybrid continuation determination model 700 supports embodiments in which continuation eligibility is determined by combining precomputed continuation data with runtime evaluation, thereby enabling flexible and scalable wager evaluation. The hybrid continuation determination model 700 further defines a dual-phase evaluation framework in which precomputed data establishes a baseline continuation structure. In contrast, runtime evaluation dynamically refines continuation outcomes at each crash stage.

The hybrid continuation determination model 700 comprises a precomputation module 702 and an eligibility determination module 704. The precomputation module 702 and the eligibility determination module 704 operate in coordination with the round state generator and the survival engine to determine continuation eligibility of wagers at each crash stage. The interaction between the precomputation module 702 and the eligibility determination module 704 is governed through defined data exchange interfaces, ensuring that precomputed continuation data is consistently accessible and correctly interpreted during runtime evaluation.

The precomputation module 702 is configured to generate precomputed continuation data for wagers before the initiation of the shared multiplayer game round. The precomputed continuation data may include stage-specific continuation eligibility values, continuation indicators, or probability values corresponding to each crash stage. In certain embodiments, the precomputation module 702 generates the player continuation data as part of the round state data before initiation of the shared multiplayer game round. The precomputation module 702 further structures the generated continuation data using indexed mappings between wager identifiers and crash stage identifiers, enabling efficient retrieval during runtime processing.

In some implementations, the precomputed continuation data specifies whether a wager is eligible to continue at each crash stage. In other implementations, the precomputed continuation data comprises probability values or parameters that are later used during runtime evaluation. The precomputation module 702 may utilize randomization processes, one or more random seeds, or deterministic algorithms to generate the precomputed continuation data. The generated precomputed continuation data is stored in association with corresponding seed values or generation parameters, enabling deterministic reconstruction of continuation eligibility during audit or replay scenarios.

The eligibility determination module 704 is configured to determine continuation eligibility of wagers at each crash stage using both the precomputed continuation data and runtime evaluation. The eligibility determination module 704 may retrieve stage-specific continuation eligibility values from the player continuation data and apply runtime evaluation logic to determine whether each wager continues or terminates responsive to the multiplier reaching a crash stage. The runtime evaluation logic is executed in sync with crash stage detection events, ensuring that continuation determination occurs within defined evaluation windows without affecting the consistency of multiplier progression.

In certain scenarios, the eligibility determination module 704 uses precomputed continuation indicators directly to determine continuation eligibility without further computation. In one scenario, the eligibility determination module 704 performs runtime evaluation using probability values included in the precomputed continuation data, which may involve generating random values using one or more random seeds and comparing such values with probability thresholds. The comparison between generated random values and probability thresholds is performed using deterministic evaluation functions, ensuring consistent outcomes for identical inputs across repeated executions.

In one implementation, the eligibility determination module 704 combines precomputed continuation data with additional runtime parameters, including current multiplier value, wager-specific attributes, or dynamically generated random values, to determine continuation eligibility. This hybrid approach allows the system to incorporate both predetermined continuation structures and dynamic evaluation conditions. The combination logic applies weighted or rule-based functions to integrate precomputed values with runtime inputs, enabling adaptive continuation decisions while preserving baseline fairness constraints defined during precomputation.

The hybrid continuation determination model 700 enables flexibility in determining continuation eligibility by allowing partial precomputation of continuation data while retaining the ability to perform runtime evaluation. This approach may improve computational efficiency by reducing runtime processing requirements while maintaining adaptability and variability in continuation outcomes. The hybrid continuation determination model 700 further optimizes resource utilization by offloading computation-intensive operations to the precomputation phase while reserving lightweight decision logic for real-time execution during gameplay.

In one scenario, the precomputation module 702 generates precomputed continuation data before initiation of the shared multiplayer game round, and the eligibility determination module 704 determines continuation eligibility of wagers at each crash stage using a combination of the precomputed continuation data and runtime evaluation. This hybrid continuation determination model 700 enables staged continuation of wagers while supporting both deterministic and probabilistic evaluation mechanisms within the shared multiplayer game round. The operational workflow is executed as a repeatable hybrid evaluation cycle at each crash stage and is recorded with associated parameters and outcomes, enabling traceability, reproducibility, and verification of continuation decisions across the game lifecycle.

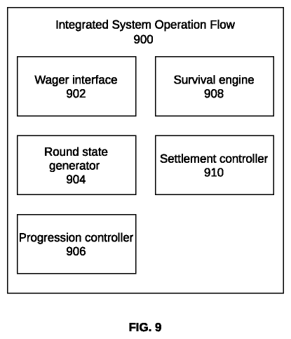

FIG. 8 illustrates a shared multiplayer game round with independent wager outcomes 800 in accordance with an exemplary embodiment of the present invention. The shared multiplayer game round with independent wager outcomes 800 is configured to demonstrate the operation of the system in which a single multiplier is shared across multiple wagers. In contrast, continuation and termination outcomes of the wagers are determined independently. The architecture further establishes a logical separation between shared state variables associated with multiplier progression and individual wager state variables associated with continuation eligibility and termination, thereby enabling concurrent evaluation without interfering with global round consistency. The illustration of FIG. 8 represents a core operational concept in which the system maintains a shared multiplayer game round while allowing individual wagers to progress differently based on continuation eligibility.

The shared multiplayer game round with independent wager outcomes 800 consists of a single multiplier 802, a plurality of wagers 804, and a demonstration 806, participating within the shared multiplayer game round. The progression controller controls the single multiplier 802 and advances according to crash-stage data generated by the round-state generator. The single multiplier 802 is a common progression parameter shared across all wagers in the multiplayer game round. The single multiplier 802 is maintained as a synchronized system-wide variable distributed across client interfaces through a real-time communication layer, ensuring consistency of multiplier values across all participants with bounded latency constraints

The plurality of wagers 804 corresponds to wagers received through the wager interface and associated with the shared multiplayer game round. The plurality of wagers 804 is evaluated independently by the survival engine using player continuation data to determine whether the respective wager continues or terminates at each crash stage.

During the progression of the shared multiplayer game round, the single multiplier 802 is incrementally advanced by the progression controller toward successive crash stages defined in the crash stage data. At each crash stage, the survival engine evaluates multiple wagers 804 using stage-specific continuation eligibility values. Based on the evaluation, some of the wagers 804 may be determined to be eligible for continuation, while others may be determined to be ineligible and therefore terminated. The evaluation is performed within a synchronized evaluation window triggered by a pause event in multiplier progression, ensuring that all wagers are assessed against the same multiplier value and crash stage boundary

The illustration 800 demonstrates that, although all multiple wagers 804 share the same single multiplier 802 and are subject to the same crash stage sequence. The continuation or termination of each wager is determined independently. This results in different wagers terminating at different crash stages or continuing through multiple stages depending on their respective continuation eligibility.

The system maintains wagers determined to continue as the same original wagers within the shared multiplayer game round, while wagers that are terminated are resolved independently by the settlement controller. Thus, the shared multiplayer game round persists as long as at least one wager remains in a continuation state. In contrast, terminated wagers are settled based on the multiplier value at their respective termination points. The continuation of the shared round is governed by a termination condition in which the round concludes only when all wagers have transitioned out of active or continuation states, or when a final crash condition defined in the crash stage data is reached.

The shared multiplayer game round with independent wager outcomes 800 further demonstrates 806 that the system decouples multiplier progression from individual wager outcomes. The single multiplier 802 continues to progress irrespective of the termination of individual wagers, and only those wagers that remain eligible for continuation participate in subsequent progression. This decoupling enables non-blocking settlement processing, and terminated wagers are processed asynchronously by the settlement controller without introducing latency into the multiplier progression pipeline.

In one scenario, the shared multiplayer game round with independent wager outcomes 800 provides a unified gameplay environment in which all wagers experience the same multiplier progression while maintaining individualized continuation and termination outcomes. This structure enables the staged continuation of wagers within a shared multiplayer game round and supports independent settlement of wagers based on their respective termination points, thereby achieving the combined functionality of shared progression and individualized outcomes as defined by the system. In an exemplary scenario, multiple players participate in a single round where the multiplier progresses from an initial value through predefined crash stages. At each stage, a subset of wagers continues based on probabilistic eligibility. In contrast, others terminate and are settled, thereby demonstrating concurrent progression and divergence of wager outcomes within a single synchronized round instance.

FIG. 9 illustrates an integrated system operation flow 900 in accordance with an exemplary embodiment of the present invention. The integrated system operation flow 900 is configured to represent the end-to-end interaction of system components for managing the staged continuation of wagers within a shared multiplayer game round. The integrated system operation flow 900 demonstrates coordination among a wager interface 902, a round state generator 904, a progression controller 906, a survival engine 908, and a settlement controller 910, thereby bridging the system's functional modules. The flow 900 further establishes a sequential yet partially parallel execution pipeline in which data generated at earlier stages is persistently stored and asynchronously accessed by downstream components to ensure low-latency and scalable operation.

The wager interface 902 is configured to receive wagers associated with the shared multiplayer game round. The wagers may be submitted by one or more players through the wager interface before initiation of the shared multiplayer game round. The wager interface may capture wager parameters, including wager amounts and participation data, and transmit the received wagers for processing. The wager interface 902 further validates received wagers using predefined validation rules, including format validation, balance verification, and session integrity checks, and assigns unique wager identifiers to enable traceability throughout the system operation flow.

The round state generator 904 generates round state data based on the received wagers. The round-state data includes crash-stage data and player continuation data. The crash stage data comprises an ordered sequence of crash multipliers that define successive crash stages. In contrast, the player continuation data comprises stage-specific continuation-eligibility values associated with the wagers. In certain embodiments, the round state generator generates the round state data before initiation of the shared multiplayer game round. The round state generator 904 further stores the generated round state data in a memory module with indexed access structures, and associates the data with a unique round identifier to enable synchronized retrieval across system components during gameplay.

The progression controller 906 initiates the progression of a multiplier using the crash stage data. The progression controller 906 controls the multiplier such that it progresses according to predefined rules and reaches successive crash stages defined in the crash stage data. The progression controller 906 maintains the shared multiplayer game round during multiplier progression. The progression controller 906 distributes real-time multiplier updates to connected client systems through a communication interface and enforces deterministic progression behavior using precomputed crash stage data to ensure consistency across all participants.

The survival engine 908 evaluates active wagers using the player continuation data to determine whether each wager continues or terminates responsive to the multiplier reaching a crash stage. The survival engine 908 retrieves stage-specific continuation eligibility values and determines continuation eligibility for each wager independently. Wagers determined to be eligible for continuation are maintained in a continuation state, while wagers determined to be ineligible are transitioned into a terminated state. The evaluation is executed within a synchronized processing window triggered by a pause in multiplier progression and uses parallel processing techniques to support high-throughput evaluation of large volumes of concurrent wagers.

In certain scenarios, continuation evaluation and settlement execution are performed as logically decoupled and concurrently executable processes within the shared multiplayer game round. While continuation eligibility is evaluated at crash stages within a synchronized evaluation window, settlement processing for terminated wagers may be executed asynchronously without interrupting multiplier progression for continuing wagers. This non-blocking execution model enables continuous multiplier progression for eligible wagers while allowing independent and parallel resolution of terminated wagers, thereby improving system throughput and scalability in high-concurrency multiplayer environments.

At step 910, the settlement controller 910 determines settlement outcomes for wagers that are terminated. The settlement controller determines a settlement outcome based on a multiplier value at a termination point responsive to termination of a wager. In one scenario, the settlement controller 910 calculates payouts for wagers terminated by a cash-out instruction based on the multiplier value at the time of termination. The settlement controller 910 resolves terminated wagers independently while the shared multiplayer game round continues for wagers determined to continue. The settlement controller 910 executes settlement operations atomically, ensuring the consistency of account updates and the persistence of transaction records, and supports asynchronous processing so that settlement execution does not delay ongoing multiplier progression for continuing wagers.

In operation, the integrated system operation flow 900 enables coordinated functioning of the system components to support the staged continuation of wagers within the shared multiplayer game round. The wager interface 902 receives wagers, the round state generator 904 generates round state data, including crash stage data and player continuation data, the progression controller 906 controls multiplier progression using the crash stage data, the survival engine 908 evaluates continuation eligibility at successive crash stages, and the settlement controller 910 determines settlement outcomes for terminated wagers. This integrated operation allows the system to maintain a shared multiplayer game round while enabling independent continuation and termination outcomes for individual wagers. In an exemplary scenario, multiple wagers are received and grouped into a single round instance. Following this, precomputed crash-stage data governs the progression of multipliers. At each detected crash stage, the system performs synchronized evaluation and selective continuation of wagers while concurrently settling terminated wagers, thereby achieving a continuous, non-blocking gameplay loop.

In certain scenarios, multiplier progression, crash stage detection, continuation eligibility evaluation, and settlement determination are performed in a server-side authoritative execution environment. At the same time, client devices serve as presentation layers that receive synchronized state updates. The authoritative environment ensures that all multiplier values, crash stage transitions, and continuation determinations are centrally controlled and validated, thereby preventing client-side manipulation and ensuring fairness across all participants. Client-side interfaces receive synchronized updates via the network module and render multiplier progression, wager states, and settlement outcomes based on the server-authoritative state.

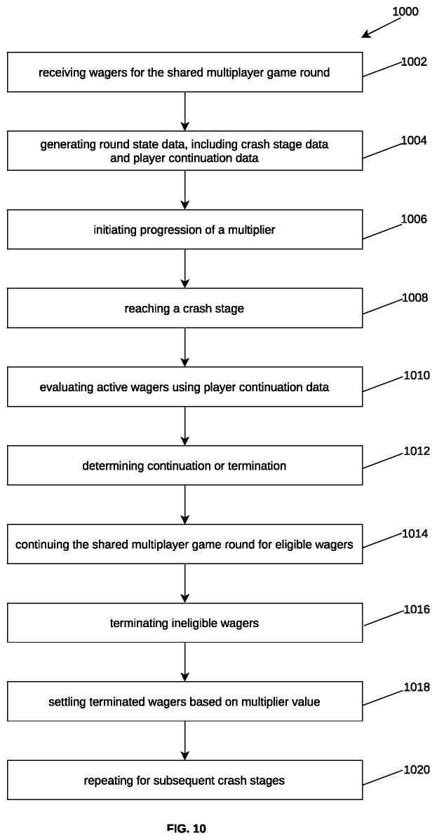

FIG. 10 illustrates a flowchart of a method 1000 for managing staged continuation of wagers within a shared multiplayer game round in accordance with an exemplary embodiment of the present invention. The method 1000 comprises the steps of: a) receiving 1002 wagers; b) generating 1004 round state data; c) initiating 1006 multiplier progression; d) detecting 1008 a crash stage; e) evaluating 1010 active wagers; f) determining 1012 continuation or termination; g) maintaining 1014 continuation wagers; h) transitioning 1016 terminated wagers; i) settling 1018 terminated wagers; and j) repeating 1020 for successive crash stages.

The method 1000 receives 1002 wagers associated with the shared multiplayer game round. Receiving wagers comprises accepting wager input data from one or more participants and registering each wager within a common round context. Each wager is associated with identifiers including wager amount, player identifier, and round identifier, enabling correlation of multiple wagers within the same multiplayer session. The received wagers are stored in a structured data repository to enable indexed access during subsequent evaluation stages. This step establishes the population of wagers that will be subjected to shared multiplier progression while retaining individual evaluation capability.

The method generates 1004 round-state data points, including crash-stage data and player continuation data. The crash stage data defines an ordered sequence of crash multipliers representing discrete evaluation points during multiplier progression. The player continuation data defines stage-specific continuation eligibility values mapped to each wager and corresponding crash stage. The generation of round-state data establishes a deterministic or probabilistic framework governing both shared multiplier progression and individualized wager outcomes. In certain implementations, the crash stage data and the player continuation data are generated independently to decouple progression behavior from continuation logic.

The method initiates a 1006 progression of a multiplier. The multiplier is initialized at a predefined starting value and increases over time according to configured progression rules. The progression may be continuous, step-wise, or dynamically adjusted based on system parameters. The multiplier functions as a shared state variable that applies uniformly to all wagers within the shared multiplayer game round, thereby providing a common progression reference for all subsequent evaluation operations.

The method detects 1008, a crash stage when the multiplier reaches a value corresponding to a crash multiplier defined in the crash stage data. Detection of the crash stage is performed by comparing the current multiplier value with the ordered sequence of crash multipliers. Upon detection, a synchronized evaluation point is established. In certain implementations, multiplier progression is temporarily paused or regulated to create a deterministic evaluation window, ensuring that all wagers are evaluated against the same multiplier value and stage boundary.

The method evaluates 1010 active wagers using the player continuation data. Active wagers are identified as wagers that have not transitioned into a terminated or settled state before the current crash stage. For each active wager, the method retrieves stage-specific continuation eligibility values corresponding to the detected crash stage. The retrieval may involve accessing indexed mappings, lookup tables, or matrix structures that associate wagers with continuation parameters. This evaluation step prepares each wager for independent eligibility determination while maintaining synchronization across the shared round.

The method determines 1012, continuation, or termination of each active wager based on the retrieved continuation eligibility values. The determination is performed independently for each wager, allowing distinct outcomes at the same crash stage. In certain embodiments, continuation eligibility is determined using explicit continuation indicators. In another scenario, continuation eligibility is determined by comparing probability values with random values derived from one or more random seeds. The determination process may use precomputed continuation data, runtime evaluation, or a hybrid of both.

In certain scenarios, the shared multiplayer game round terminates upon satisfaction of a predefined termination condition, including at least one of: (i) all wagers having transitioned into a terminated or settled state, or (ii) completion of a final crash stage defined in the crash stage data. Upon termination of the round, any remaining active wagers may be automatically settled based on the final multiplier value or predefined settlement rules.

The method maintains 1014, the shared multiplayer game round for wagers determined to continue. Wagers satisfying continuation criteria are retained in an active or continuation state and remain eligible for participation in subsequent multiplier progression and future crash stage evaluations. This step ensures that the shared multiplayer game round persists while selectively reducing the set of active wagers based on continuation eligibility outcomes.

The method transitions 1016, wagers determined to be ineligible for continuation into a terminated state. Transitioning comprises updating wager state records to reflect termination and excluding such wagers from further evaluation in subsequent crash stages. Terminated wagers are logically separated from continuing wagers while maintaining their association with the shared multiplayer game round for settlement processing.

The method settles 1018 and terminates wagers based on a multiplier value at a termination point. The termination point corresponds to the multiplier value at which the wager ceases to participate, including termination at a crash stage or in response to a cash-out instruction. Settlement comprises calculating the outcome using the multiplier, the wager amount, and the applicable payout rules, then recording the outcome and updating the associated records. This step enables independent resolution of terminated wagers while the shared multiplayer game round continues for remaining wagers.

The method repeats 1020, the sequence of detecting crash stages, evaluating active wagers, determining continuation or termination, maintaining continuation wagers, transitioning terminated wagers, and settling terminated wagers, for successive crash stages as the multiplier progresses. The iterative execution continues until a termination condition is met, including exhaustion of active wagers or completion of the defined crash stage sequence. This repeated evaluation mechanism enables staged continuation of wagers within the shared multiplayer game round while preserving independent outcome determination.

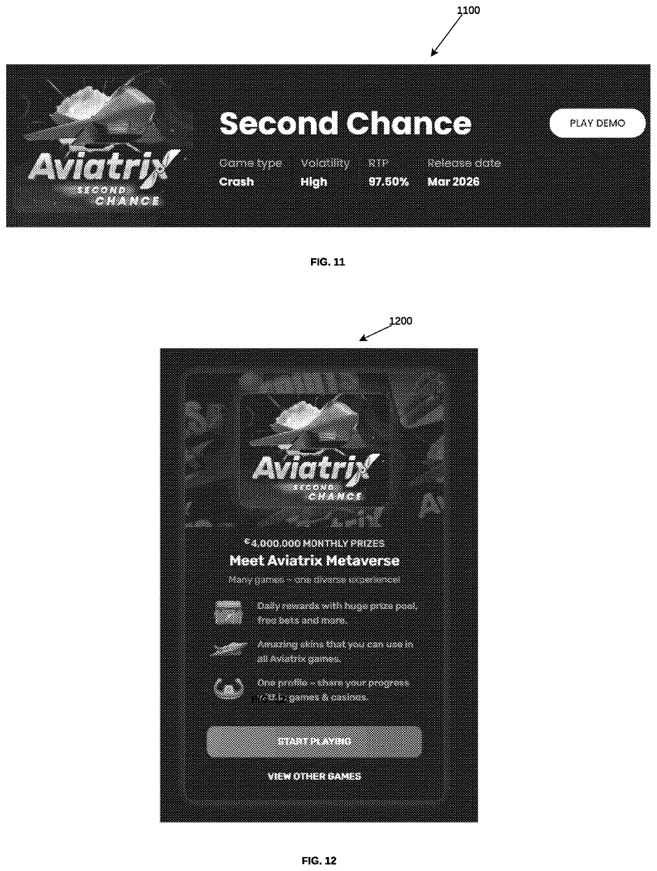

FIG. 11 illustrates a wager interface 1100 configured as a banner display for presenting a selectable wagering instance in accordance with an exemplary embodiment of the present invention. The wager interface 1100 prominently includes a user-selectable control labeled “Play Demo,” which enables a user to initiate a demo wagering session associated with the displayed wagering instance. The “Play Demo” control serves as an entry point that allows the user to experience the wagering functionality without committing to full participation, thereby facilitating evaluation of the wagering experience before progressing within the wagering environment.

FIG. 12 illustrates a wager interface 1200 configured as an onboarding screen that introduces features of the wagering environment in accordance with an exemplary embodiment of the present invention. The wager interface 1200 includes a primary user-selectable control labeled “Start Playing,” which enables the user to transition from the onboarding stage into an active wagering session. The presence of the “Start Playing” control provides a clear progression point from informational content to execution of wagering activity within the system.

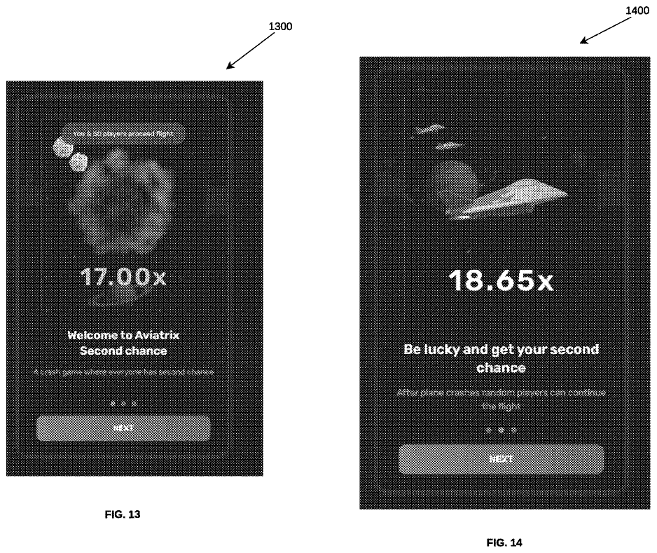

FIG. 13 illustrates a wager interface 1300 depicting an instructional gameplay screen in which a multiplier-based wagering event is visually represented in accordance with an exemplary embodiment of the present invention. The wager interface 1300 displays a graphical environment that includes a trajectory path and a multiplier value that increases over time, thereby demonstrating how a wagering outcome progresses during gameplay. A message region is displayed indicating player-related activity, and descriptive text explains that winnings are dependent on when a user exits relative to the multiplier. The wager interface 1300 further includes a navigation control labeled “Next,” which enables the user to proceed after viewing the illustrated multiplier progression and associated gameplay explanation.

FIG. 14 illustrates a wager interface 1400 depicting a continuation of the gameplay scenario in accordance with an exemplary embodiment of the present invention. A flight-based graphical element progresses along a trajectory while a multiplier value is displayed. The wager interface 1400 further depicts termination of the trajectory corresponding to a crash event, after which a “Second Chance” feature is provided to the user, enabling re-engagement in the wagering event or continuation under modified conditions. This depiction highlights both the risk of abrupt termination and the availability of an additional opportunity following the crash. A navigation control labeled “Next” is provided to allow the user to proceed after understanding the depicted wagering behavior and the second-chance functionality.

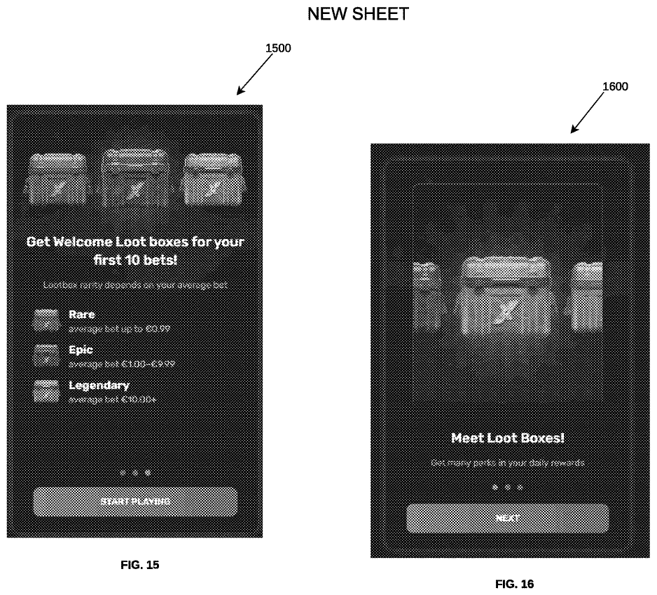

FIG. 15 illustrates a wager interface 1500 depicting reward structures associated with wagering activity in accordance with an exemplary embodiment of the present invention. The wager interface 1500 presents multiple reward containers in the form of loot boxes corresponding to different rarity levels, along with descriptive text indicating that higher-value rewards may be obtained based on gameplay performance. A user-selectable control labeled “Start Playing” is included to enable the user to initiate a wagering session directed toward obtaining such rewards.

FIG. 16 illustrates a wager interface 1600 depicting reward containers within the wagering environment in accordance with an exemplary embodiment of the present invention. The wager interface 1600 presents graphical representations of the containers along with descriptive text explaining that such containers may be earned or accessed during gameplay. A navigation control labeled “Next” enables the user to proceed after reviewing the depiction of the reward containers and their role in the wagering system.

FIG. 17 illustrates a wager interface 1700 depicting the progression of rewards based on continued participation in wagering activity in accordance with an exemplary embodiment of the present invention. The wager interface 1700 displays an enhanced reward container and descriptive text indicating that increased gameplay activity may yield better rewards. A navigation control labeled “Next” allows the user to advance after understanding the reward progression concept.

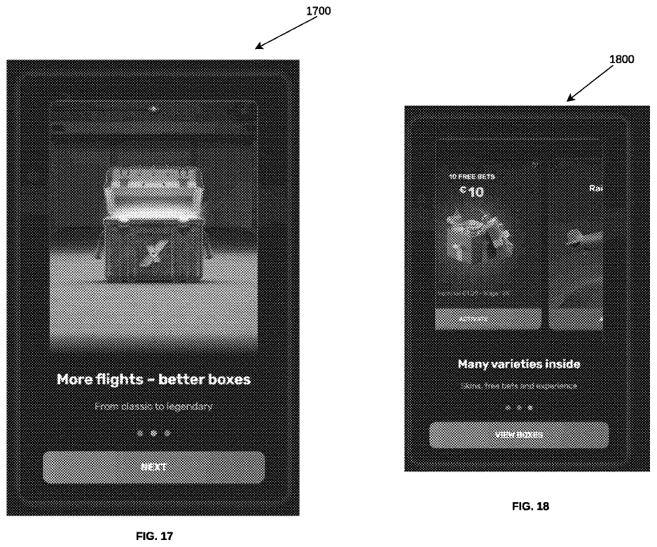

FIG. 18 illustrates a wager interface 1800 that depicts a catalog of available rewards within the wagering environment, in accordance with an exemplary embodiment of the present invention. The wager interface 1800 presents multiple reward items arranged within a display layout and includes a user-selectable control labeled “View Boxes,” which enables the user to explore the available reward containers in greater detail.

FIG. 19 illustrates a wager interface 1900 depicting a pre-event or pre-launch state of a wagering session in accordance with an exemplary embodiment of the present invention. The wager interface 1900 prominently displays a countdown indicator showing the time remaining before commencement of the wagering event, indicated by the phrase “Next Round In” followed by a decreasing time value. The wager interface 1900 further includes a wager control panel positioned along a lower portion, and a user is provided with selectable controls such as “Bet” for placing a wager and “Auto Cash Out” for defining an automated exit multiplier. Additional selectable options, such as “Auto Bet,” may also be provided to enable repeated participation across multiple rounds. The wager interface 1900 also presents informational regions, including “Prize Pool” and “Players,” which indicate the accumulated reward amount and the number of participants in the upcoming wagering event, respectively. Through the use of the terms “Next Round In,” “Bet,” “Auto Cash Out,” and “Prize Pool,” the wager interface 1900 clearly conveys to the user that a wagering round is pending. It provides the necessary controls to configure participation before initiation.

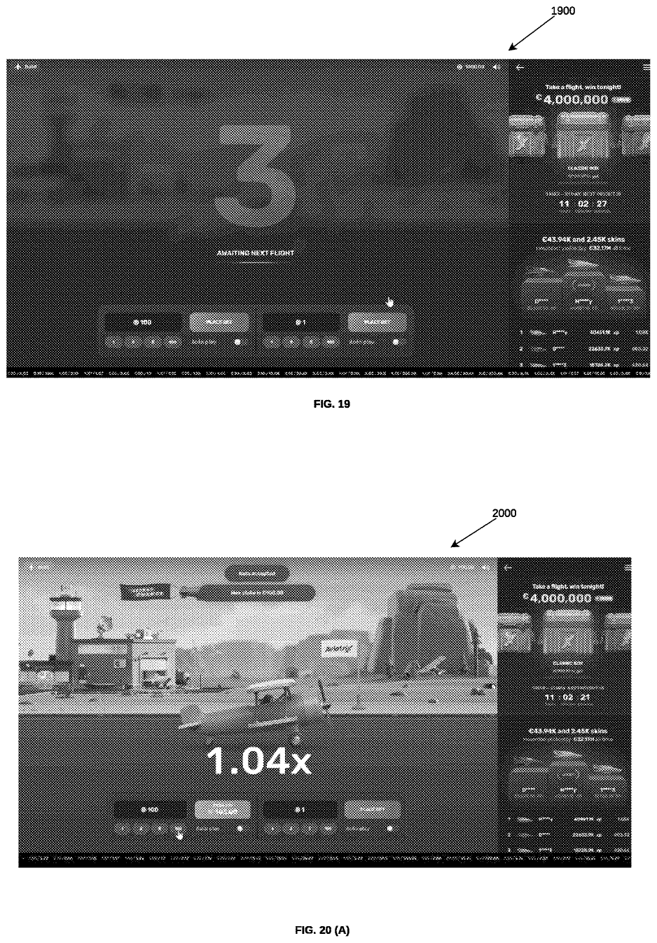

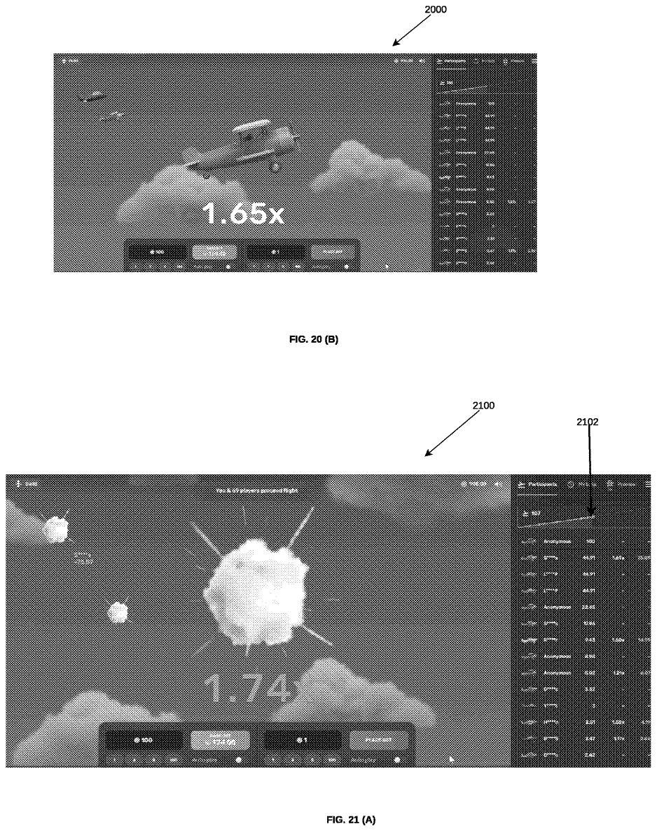

FIG. 20(A) illustrates a wager interface 2000 depicting an active wagering session following the countdown phase in accordance with an exemplary embodiment of the present invention. The wager interface 2000 displays a dynamic gameplay environment in which a graphical flight element progresses along a trajectory while a multiplier value is continuously updated in real time. The multiplier value is prominently displayed (for example, “1.04×”), indicating the current wagering multiplier associated with the ongoing session. The wager interface 2000 retains the wager control panel, including controls such as “Bet” and “Auto Cash Out,” thereby enabling the user to manage wagers during the session actively. Informational elements such as “Prize Pool” continue to be displayed and dynamically updated as participation progresses. The wager interface 2000 may further present status messaging such as “Wait For Next Round” when a wagering opportunity has concluded, thereby linking back to the countdown state depicted in FIG. 19. The inclusion and persistence of the terms “Bet,” “Auto Cash Out,” “Prize Pool,” And “Wait For Next Round” ensure continuity between the pre-event and active wagering states and provide clear, real-time feedback to the user throughout the wagering session.

FIG. 20(B) illustrates a wager interface 2000 during an active wagering session in accordance with an exemplary embodiment of the present invention. The wagering session in which a multiplier value is progressively increasing and is currently displayed as 1.65×. The wager interface 2000 further displays a cash-out option, enabling a participant to exit the wager before a crash event occurs and thereby secure winnings associated with the displayed multiplier. A participant count indicator also shows that 116 participants are currently associated with the wagering event. The wager interface 2000 further includes a graphical representation of progress corresponding to the increasing multiplier and wager activity.

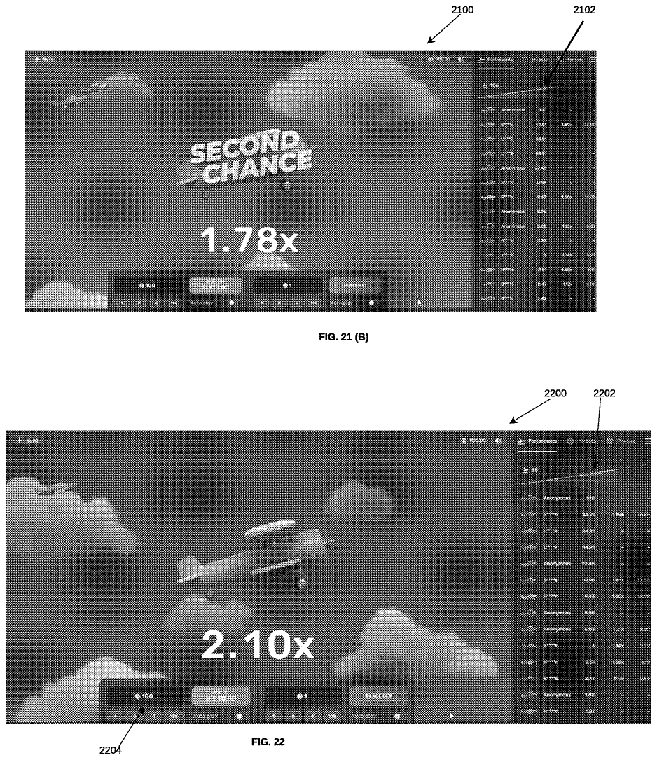

FIG. 21(A) illustrates a wager interface 2100 after a crash event has occurred in accordance with an exemplary embodiment of the present invention. The crash event has occurred at a multiplier value of 1.74×. At the time of the crash event, the interface displays 107 participants associated with the wagering session. Following the crash event, a notification banner positioned near the top portion of the interface indicates that “you and 69 players will proceed for a second chance”.

FIG. 21(B) illustrates a wager interface 2100 showing the subsequent second-chance wagering stage in accordance with an exemplary embodiment of the present invention. The second-chance wagering stage, in which the wagering session resumes from the prior crash condition. In this stage, the wager interface 2100 continues to display the multiplier progression, which increases to approximately 1.78x, while maintaining the wager information and the updated participant activity.

FIG. 22 illustrates a wager interface 2200 during the second-chance progression stage in accordance with an exemplary embodiment of the present invention. In the illustrated example, the original wager amount of 100 remains active, while the multiplier continues to progress and is displayed as 2.10×. The wager interface 2200 further indicates that the original crash event occurred at approximately 2.02×. After the crash point, a blue progression line is displayed on the graphical progress indicator, representing continued advancement of the same wager or betting session during the second-chance phase. The interface thereby visually distinguishes the original wagering progression from the continued second-chance progression while allowing eligible participants to remain engaged in the ongoing wagering event.

As used herein, the term “wager” refers to a data representation of a stake associated with a game round, including a persistent wager that remains active across multiple evaluation stages within the same round without requiring re-entry, rebuy, or duplication. The term “crash stage” refers to a defined event during multiplier progression at which one or more wagers are evaluated for termination or continuation. The term “continuation eligibility” refers to any data, rule, or indicator that determines whether a wager remains active beyond a given crash stage. The term “shared multiplayer game round” refers to a synchronized game instance in which a common multiplier progression is presented to multiple players while allowing individualized wager outcomes. The terms “module,” “engine,” and “controller” refer to software, hardware, or a combination thereof configured to perform specified operations, and may be implemented using one or more processors and memory.

A wager that is determined to continue beyond a crash stage remains the same original wager without requiring modification, duplication, or re-entry by the player. The wager persists across multiple stages within the same round. It is resolved only upon a cash-out instruction or termination at a crash stage for which continuation eligibility is not present.

Players associated with wagers that remain active after a crash stage are permitted to initiate a cash-out during a time interval between successive crash stages. Settlement in response to such a cash-out is determined based on the multiplier value at the time of the cash-out instruction. Players whose wagers do not remain active after a crash stage are not eligible to perform cash-out operations beyond that stage.

The system supports any number of crash stages greater than one, and continuation evaluation may be performed repeatedly at each crash stage in sequence, enabling progression across multiple stages within a single shared round with continuation eligibility independently determined at each stage.

The system enables real-time synchronization of a shared multiplier state across multiple client devices while supporting individualized wager outcomes through stage-based evaluation and state transitions. This coordinated control improves the operation of multiplayer gaming systems by managing concurrent state changes, reducing desynchronization, and enabling consistent resolution of wagers across clients.

Conventional multiplier games settle all wagers based on a single crash point per round, and known extensions such as insurance, rebuy, or rescue mechanisms require separate transactions or independent game states. In contrast, the present system performs multiple stage-based evaluations within the same round while maintaining the same wager active and selectively allowing continuation based on player-specific data.

Crash-stage data and continuation-eligibility data may be generated using one or more randomization processes. In some cases, such data is generated before the initiation of the round, while in other cases, continuation determinations may occur during progression based on predefined rules or random inputs, while maintaining consistency with the round state.

Data associated with crash stages, continuation eligibility, and wager outcomes may be stored to enable verification, auditing, and deterministic reconstruction of round results, including storage of random seeds, generated multipliers, and continuation indicators.

The components described as modules, engines, or controllers may be implemented as software executed by one or more processors, as hardware components, or as combinations thereof. These components may operate within a single system or across multiple networked systems and may communicate using application programming interfaces or other data exchange mechanisms. Functional separation is provided for clarity and does not require physical separation.

Referring to FIG. 1, a system architecture is shown in which player devices communicate with one or more servers that manage multiplier progression, crash stage data, and continuation evaluation. Referring to FIG. 2, a process flow is illustrated for receiving wagers, generating round state data, progressing the multiplier, evaluating continuation eligibility at crash stages, and settling wagers. Referring to FIG. 3, a timeline shows multiple crash stages and their corresponding continuation outcomes. Referring to FIG. 4, user interface states are illustrated for presenting multiplier progression, stage transitions, continuation notifications, and wager outcomes.

### ADDITIONAL EMBODIMENTS AND IMPLEMENTATION CONSIDERATIONS

The system is configured such that termination of a wager does not interrupt, reset, or otherwise affect progression of the shared multiplayer game round for other wagers. Each wager is evaluated and resolved independently at respective termination points while the shared multiplier progression continues uninterrupted for wagers maintained in a continuation state. This independent resolution model ensures that multiple wagers within the same round may terminate at different stages without requiring synchronization of termination events across all wagers, thereby preserving continuous round execution and enabling differentiated wager lifecycles within a unified system architecture.

As used herein, the terms “engine,” “module,” “controller,” or “component” refer to a combination of hardware, software, firmware, or any programmable logic configured to perform specified functions. Such elements may be implemented as standalone components, integrated circuits, distributed microservices, virtualized processes, or executable program code stored in memory and executed by one or more processors. The functional boundaries of these elements are logical in nature and may be combined, partitioned, or distributed across multiple computing environments without departing from the scope of the invention.

In alternative scenarios, the crash stage data and/or player continuation data may be generated using deterministic rules, predefined configuration tables, machine learning models, or rule-based decision systems rather than randomization processes. For example, continuation eligibility may be determined based on player attributes, wager size, historical behavior, or operator-defined progression curves. Such embodiments preserve the staged-continuation architecture while enabling controlled or adaptive gameplay dynamics.

In another scenarios, the invention may be implemented as a non-transitory computer-readable medium storing instructions that, when executed by one or more processors, cause a computing system to perform operations comprising receiving wagers, generating round state data including crash stage data and player continuation data, controlling multiplier progression, evaluating continuation eligibility of wagers at defined stages, maintaining continuation of eligible wagers within a shared multiplayer game round, and determining settlement outcomes for terminated wagers.

The present invention provides a technical solution to problems arising in networked multiplayer gaming systems, including synchronization of shared state across distributed clients, real-time evaluation of individualized wager outcomes within a common execution environment, and efficient processing of concurrent wager lifecycles without interrupting shared gameplay progression. The invention improves computer functionality by introducing a structured state management framework, deterministic evaluation pipelines, and distributed processing mechanisms that enable scalable and low-latency operation of multiplayer game rounds. Accordingly, the invention is not directed to an abstract idea but to a specific improvement in computer-based gaming systems and networked processing architectures.

The foregoing description provides sufficient detail to enable a person of ordinary skill in the art to make and use the claimed invention without undue experimentation. Various implementation details, including data structures, processing flows, and system architectures, have been described with reference to exemplary embodiments. It will be understood that variations, substitutions, and modifications may be made without departing from the scope of the invention, and that the described embodiments are illustrative rather than limiting.

It is intended that the appended claims and their equivalents define the scope of the invention. The description of specific embodiments is not intended to limit the invention to the precise forms disclosed. Features described in connection with one embodiment may be combined with features of other embodiments. Furthermore, the order of steps described in method embodiments may be modified unless explicitly stated otherwise, and structural components may be rearranged or implemented in alternative configurations.

In certain cases, termination of wagers in response to cash-out instructions is prioritized over system-triggered termination events when they occur within a defined temporal proximity window relative to a crash stage. The system may use server-authoritative timestamps and latency-compensation mechanisms to ensure fair and deterministic resolution of such events, thereby preventing ambiguity in settlement outcomes when user-initiated and system-triggered termination conditions occur concurrently.

Although specific cases describe two or more crash stages, the system is configurable to support any number of sequential crash stages, including dynamically determined stage counts based on system configuration or runtime parameters. Each stage may independently define continuation eligibility conditions, enabling extension to second-, third-, fourth-, or higher-order continuation models without modifying the underlying system architecture.

1. A system for managing staged continuation of wagers within a shared multiplayer game round, comprising:
a wager interface to receive wagers associated with the shared multiplayer game round;
a round state generator to generate round state data, including crash stage data and player continuation data based on the received wagers;
a progression controller to initiate and control the progression of a game multiplier using the crash stage data;
a survival engine to evaluate active wagers using the player continuation data to determine whether each wager continues or terminates responsive to the multiplier reaching a crash stage; and
a settlement controller to determine a settlement outcome based on the multiplier value at a termination point responsive to termination of a wager;
wherein the progression controller maintains wagers determined to continue as the same original wagers within the shared multiplayer game round, while terminated wagers are resolved independently.

2. The system according to claim 1, wherein the crash stage data comprises an ordered sequence of two or more crash multipliers.

3. The system according to claim 1, wherein the crash stage data defines successive crash stages occurring during multiplier progression.

4. The system according to claim 1, wherein the round state generator generates the crash stage data before initiation of the shared multiplayer game round.

5. The system according to claim 1, wherein the player continuation data comprises stage-specific continuation eligibility values.

6. The system according to claim 1, wherein the survival engine determines continuation eligibility by retrieving continuation indicators from the round state data.

7. The system according to claim 1, wherein the wagers determined to be ineligible for continuation are transitioned into a terminated state.

8. The system according to claim 1, wherein the wagers having continuation eligibility are maintained in a continuation state, allowing progression to a subsequent crash stage.

9. The system according to claim 1, wherein the progression controller temporarily pauses multiplier progression at a crash stage before evaluation of wagers.

10. The system according to claim 9, wherein the multiplier progression resumes after continuation wagers are determined.

11. The system according to claim 1, wherein the crash stage data is generated using a randomization process.

12. The system according to claim 1, wherein the player continuation data is generated independently from the crash stage data.

13. The system according to claim 1, wherein the continuation eligibility is determined using stage-specific probability values.

14. The system according to claim 13, wherein the continuation eligibility is determined using one or more random seeds.

15. The system according to claim 14, wherein the one or more random seeds are stored in a memory module to enable reproduction of continuation determinations.

16. The system according to claim 1, wherein the continuation eligibility is determined using both precomputed continuation data and runtime evaluation.

17. The system according to claim 1, wherein each wager is associated with a wager state selected from active, continuation, terminated, or settled.

18. The system according to claim 1, wherein the settlement controller calculates payouts for wagers terminated by a cash-out instruction based on the multiplier value at a time of termination.

19. A method for managing staged continuation of wagers within a shared multiplayer game round comprising:
receiving wagers for the shared multiplayer game round;
generating round state data, including crash stage data and player continuation data, based on the received wagers;
initiating the progression of a multiplier using the crash stage data;
evaluating active wagers using the player continuation data to determine whether each wager continues or terminates responsive to the multiplier reaching a crash stage;
continuing the shared multiplayer game round for wagers determined to continue as the same original wagers; and
settling terminated wagers based on the multiplier value at a termination point.

20. A method for managing staged continuation of wagers within a shared multiplayer game round, comprising:
generating round state data, including crash stage data and player continuation data;
initiating and controlling progression of a game multiplier during the shared multiplayer game round using the crash stage data;
evaluating continuation eligibility of wagers at each crash stage using the player continuation data;
transitioning wagers determined to be ineligible for continuation into terminated states;
maintaining wagers determined to be eligible for continuation in continuation states, allowing progression to a subsequent crash stage as the same original wagers; and
determining settlement outcomes for terminated wagers based on a multiplier value at a termination point;
wherein the shared multiplayer game round is maintained while wagers independently continue or terminate at different crash stages based on the player continuation data.

21. A system for managing staged continuation of wagers within a shared multiplayer game round, the system comprising:
a wager interface to receive wagers associated with the shared multiplayer game round;
a round state generator to generate round state data, including stage event data and player continuation data associated with a plurality of continuation checkpoints during the shared multiplayer game round;
a progression controller to control progression of a game parameter through successive continuation checkpoints;
a continuation evaluation engine to evaluate active wagers at respective continuation checkpoints using the player continuation data to determine whether individual wagers continue or terminate at corresponding stage events; and
a settlement controller to determine settlement outcomes for terminated wagers based on a value of the game parameter at a termination point;
wherein wagers determined to continue remain active within the shared multiplayer game round as the same original wagers without requiring re-entry, rebuy, replacement, duplication, or placement of additional wagers, and wherein terminated wagers are resolved independently while the shared multiplayer game round continues for remaining active wagers.
